(19) United States
(12) Patent Application Publication
(10) Pub. No.: US 2024/0134018 A1
(43) Pub. Date: Apr. 25, 2024

(54) IDENTIFICATION OF CHIRP RATES

(71) Applicant: SiLC Technologies, Inc., Monrovia, CA (US)

(72) Inventor: Majid Boloorian, San Diego, CA (US)

(21) Appl. No.: 17/970,508

(22) Filed: Oct. 19, 2022

(51) Int. Cl. G01S 7/4911; G01S 17/58; G01S 17/89

(52) U.S. Cl. CPC G01S 7/4911; G01S 17/58; G01S 17/89

(57) ABSTRACT

A LIDAR system includes a signal splitter configured to split a common light signal into a first light signal and a second light signal. The system also includes a signal combiner configured to combine light from the first light signal and light from the second light signal so as to form a combined signal that is beating at a beat frequency. The system also includes electronics that include a beat frequency identifier configured to identify the beat frequency of the combined signal. The electronics also included a chirp rate generator configured to calculate a chirp rate for the common light signal from the beat frequency of the combined signal.

### FIELD

The invention relates to optical devices. In particular, the invention relates to imaging systems and LIDAR systems using signals with chirped frequencies.

### BACKGROUND

There is an increasing commercial demand for LIDAR systems that can be deployed in applications such as ADAS (Advanced Driver Assistance Systems) and AR (Augmented Reality). These LIDAR systems typically output a system output signal that is reflected by objects located outside of the LIDAR system. At least a portion of the reflected light signal returns to the LIDAR system. The LIDAR system directs the received light signal to a light sensor that converts the light signal to an electrical signal. Electronics can use the light sensor output to quantify LIDAR data that indicates the radial velocity and/or distance between the object and the LIDAR system.

Many LIDAR systems chirp the frequency of the system output signal at a target chirp rate in order to enable the accurate measurement of the data. However the actual chirp rates that are achieved are often different than the target chirp rate. This difference between the target chirp rate and the actual chirp rate is a substantial source of errors in the LIDAR data. As a result, there is a need for a LIDAR system that corrects for the differences between the target chirp rates and the actual chirp rates.

### SUMMARY

A LIDAR system includes a signal splitter configured to split a common light signal into a first light signal and a second light signal. The system also includes a signal combiner configured to combine light from the first light signal and light from the second light signal so as to form a combined signal that is beating at a beat frequency. The system also includes electronics that include a beat frequency identifier configured to identify the beat frequency of the combined signal. The electronics also included a chirp rate generator configured to calculate a chirp rate for the common light signal from the beat frequency of the combined signal.

A method of operating a LIDAR system includes splitting a common light signal into a first light signal and a second light signal. The method also includes combining light from the first light signal and light from the second light signal so as to form a combined signal that is beating at a beat frequency. The method further includes identifying the beat frequency of the combined signal and calculating a chirp rate for the common light signal from the calculated beat frequency of the combined signal.

### BRIEF DESCRIPTION OF THE FIGURES

FIG. 1A illustrates an imaging system that includes a chip with a photonic circuit.

FIG. 1B illustrates another embodiment of an imaging system that includes a photonic circuit chip.

FIG. 1C illustrates another embodiment of an imaging system that includes a photonic circuit chip.

FIG. 2 is a schematic of an imaging system that includes multiple different cores on a chip.

FIG. 3A through FIG. 3B illustrate an example of a signal processor that is suitable for use as the signal processor in a LIDAR system constructed according to FIG. 1A and FIG. 1B. FIG. 3A is a schematic of an example of a suitable optical-to-electrical assembly for use in the signal processor.

FIG. 3B provides a schematic of the relationship between electronics and the optical-to-electrical assembly of FIG. 3A.

FIG. 3C illustrates the frequency of a signal output from the imaging system over time.

FIG. 3D provides a schematic of the relationship between electronics and the optical-to-electrical assembly of FIG. 3A.

FIG. 3E is a schematic of another relationship between sensors in the optical-to-electrical assembly from FIG. 3A and electronics in the LIDAR system.

FIG. 3F through FIG. 3H illustrate an example of a chirp rate identifier that is suitable for use as the chirp rate identifier in the imaging systems of FIG. 1A through FIG. 1C. FIG. 3F is a schematic of an example of a suitable optical-to-electrical assembly for use in the chirp rate identifier.

FIG. 3G provides a schematic of the relationship between electronics and the optical-to-electrical assembly of FIG. 3F.

FIG. 3H illustrates the schematic of FIG. 3B modified to include a chirp rate generator shown in FIG. 3G.

FIG. 3I illustrates the schematic of FIG. 3D modified to include the chirp rate generator shown in FIG. 3G.

FIG. 3J illustrates the schematic of FIG. 3E modified to include the chirp rate generator shown in FIG. 3G.

FIG. 4 is a cross section of a silicon-on-insulator wafer.

FIG. 5A and FIG. 5B illustrate an example of an optical switch that includes cascaded Mach-Zehnder interferometers. FIG. 5A is a topview of the optical switch.

FIG. 5B is a cross section of the optical switch shown in FIG. 5A taken along the line labeled B in FIG. 5A.

FIG. 6 illustrates the LIDAR system of FIG. 2 modified to have multiple signal directors that each receives LIDAR output signals from a different core.

FIG. 7 illustrates the LIDAR system of FIG. 2 where a light source is located external to the chip.

FIG. 8 illustrates a portion of a LIDAR chip that includes a reference waveguide used in conjunction with a beam dump.

### DESCRIPTION

The imaging system includes a chirp rate identifier that can be operated by electronics so as to identify the chirp rate of light signals output from the imaging system. The identified chirp rates can be used in the calculation of LIDAR data that indicates a radial velocity and/or distance between the imaging system and an object located outside of the imaging system. Using the identified chirp rates to calculate LIDAR data rather than using target chirp rates reduces errors in the LIDAR data.

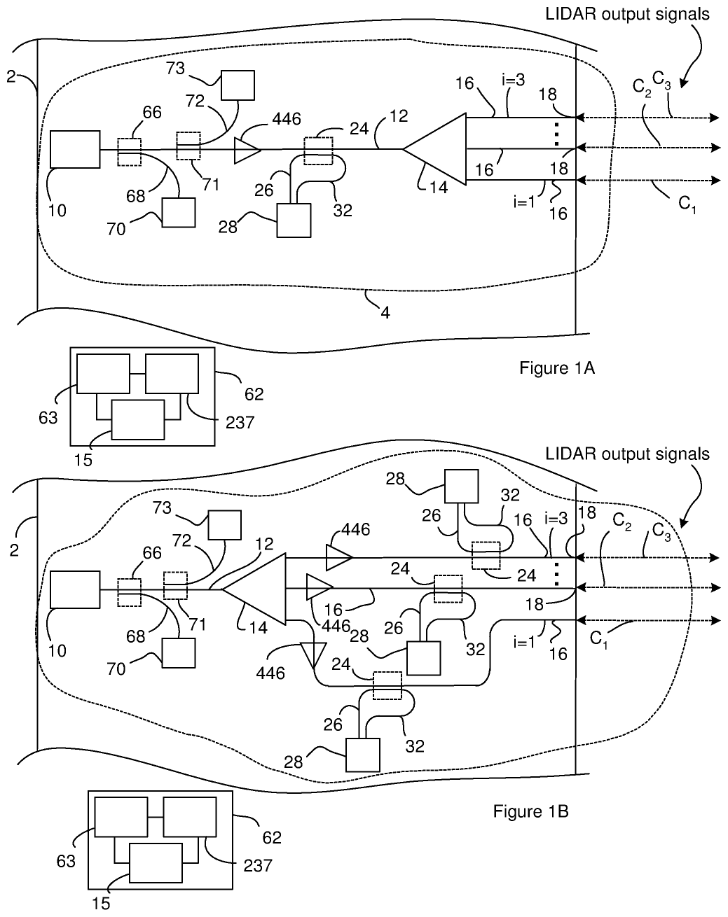

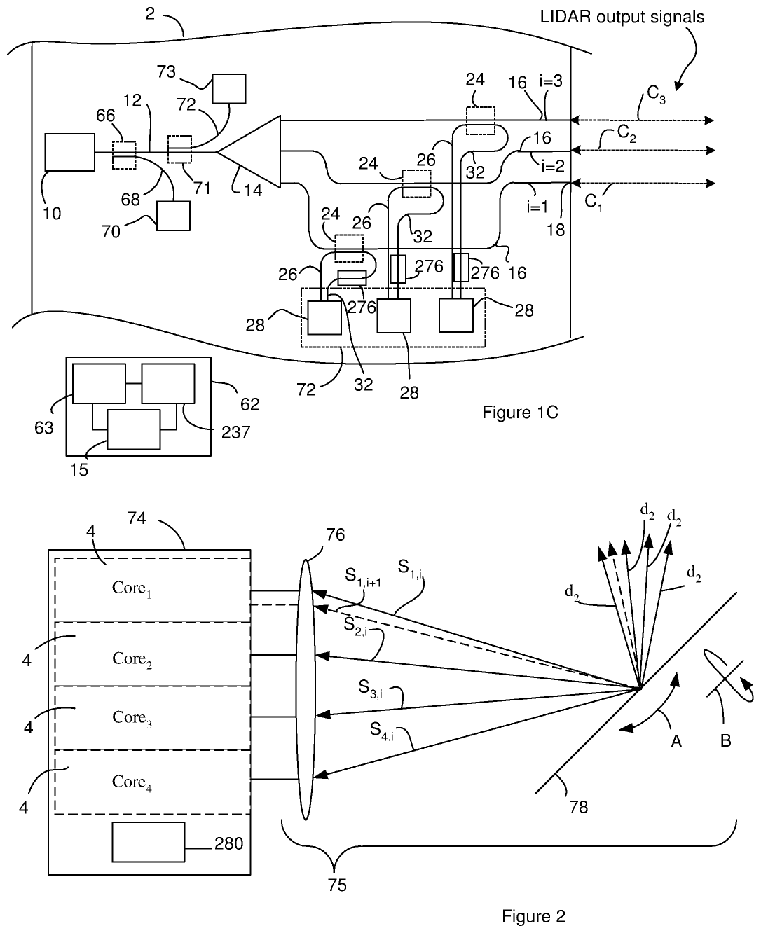

FIG. 1A is a schematic of a portion of a LIDAR system that includes a LIDAR chip 2. FIG. 1A includes a topview of a portion of the LIDAR chip 2. The LIDAR chip can be a semiconductor chip such as a silicon-on-insulator chip. The LIDAR chip includes a LIDAR core 4. The LIDAR core 4 includes a photonic integrated circuit.

The LIDAR core 4 can include a light source 10 that outputs an outgoing LIDAR signal. The LIDAR core includes a utility waveguide 12 that receives the outgoing LIDAR signal from the light source 10. The utility waveguide 12 carries the outgoing LIDAR signal to a signal director 14. The LIDAR system can include electronics that operate the signal director 14. For instance, the electronics can include a director controller 15 that operates the signal director 14 so as direct light from the light source output signal to any one of multiple different alternate waveguides 16. There are N alternate waveguides and each of the alternate waveguides 16 is associated with an alternate waveguide index i where i has a value from 1 to N. Suitable values of N include, but are not limited to, values less than 128, 64, or 32 and/or greater than 2, 8, or 16. In one example, N is between 2 and 128.

Each of the alternate waveguides 16 can receive the outgoing LIDAR signal from the signal director 14. When any one of the alternate waveguides 16 receives the outgoing LIDAR signal, the alternate waveguides 16 serves an active waveguide and carries the outgoing LIDAR signal to a port 18 through which the outgoing LIDAR signal can exit from the LIDAR chip and serve as a LIDAR output signal. Accordingly, the outgoing LIDAR signal is output from the active waveguide.

Light signals that result from the outgoing LIDAR signal being directed to the alternate waveguide 16 with alternate waveguide index i are classified as light signals carrying channel (Cᵢ). Accordingly, each of the LIDAR output signals is associated with a different one of the alternate waveguide indices i=1 through N. For instance, the path of the LIDAR output signal that carries the channel with alternate waveguide index 2 is labeled C₂ in FIG. 1A. For the purposes of illustration, the LIDAR system is shown as generating three LIDAR output signals (N=3) labeled C₁ through C₃. Each of the different LIDAR output signals can carry a different channel, however, each of the different channels can carry the same selections of wavelength(s) or substantially the same selections of wavelength(s).

A LIDAR input signal returns to the LIDAR chip such that a LIDAR input signal carrying channel Cᵢ enters the alternate waveguide 16 that is associated with the same alternate waveguide index i. As a result, LIDAR input signals carrying different channels are directed to different alternate waveguides. The portion of the LIDAR input signal that enters an alternate waveguide 16 serves as an incoming LIDAR signal. As a result, the alternate waveguide that receives the incoming LIDAR signal can guides an outgoing LIDAR signal while also guiding the incoming LIDAR signal in the opposite direction. The alternate waveguide 16 that receives the incoming LIDAR signal carries the incoming LIDAR signal to the signal director 14. The signal director 14 outputs the incoming LIDAR signal on the utility waveguide 12.

The utility waveguide 12 carries the incoming LIDAR signal to a 2×2 splitter 24 that moves a portion of the incoming LIDAR signal from the utility waveguide 12 onto a comparative waveguide 26 as a comparative signal. The comparative signal includes light from the outgoing LIDAR signal that has exited from the imaging system, that has been reflected by an object located outside of the imaging system, and that has returned to the imaging system. The comparative waveguide 26 carries the comparative signal to a signal processor 28 for further processing. Suitable splitters 24 include, but are not limited to, optical couplers, y-junctions, and MMIs. In some instances, the splitter 24 is configured such that the power of the incoming LIDAR signal is divided evenly or substantially evenly between the utility waveguide 12 and the comparative waveguide 26.

The utility waveguide 12 also carries the outgoing LIDAR signal to the splitter 24. The splitter 24 moves a portion of the outgoing LIDAR signal from the utility waveguide 12 onto a reference waveguide 32 as a reference signal. The reference waveguide 32 carries the reference signal to the signal processor 28 for further processing.

As will be described in more detail below, the signal processor 28 combines the comparative signal with the reference signal to form a composite signal that carries LIDAR data for a sample region on the field of view. Accordingly, the composite signal can be processed so as to extract LIDAR data (radial velocity and/or distance between a LIDAR system and an object external to the LIDAR system) for the sample region.

The LIDAR chip can include a chirp branch for identifying a chirp rate of the outgoing LIDAR signal. Accordingly, the chirp branch can identify the chirp rate of signals output from the LIDAR system for the generation of LIDAR data such as system output signals. The chirp branch includes a signal splitter 66 that moves a portion of the outgoing LIDAR signal from the utility waveguide 12 onto a common waveguide 68. The coupled portion of the outgoing LIDAR signal serves as a common signal. The common waveguide 68 carries the common signal to a chirp rate identifier 70. Examples of suitable signal splitters 66 include, but are not limited to, directional couplers, Y-junctions, and MMIs.

The electronics 62 can include a light source controller 63. The light source controller 63 can operate the light source such that the outgoing LIDAR signal, and accordingly a system output signal, has a particular frequency versus time pattern. For instance, the light source controller 63 can operate the light source such that the outgoing LIDAR signal, and accordingly a system output signal, has different chirp rates during different data periods.

The light source controller 63 can tune the voltage and/or current applied to the light source so as to achieve the desired frequency versus time pattern in light signals that include light from the outgoing LIDAR signal. When the light source 10 is a gain element or laser chip, the light source controller 63 can change the frequency of the outgoing LIDAR signal by changing the level of electrical current applied through the gain element or laser cavity. Additionally or alternately, the light source 10 can include a modulator (not shown) configured to modulate the frequency of the outgoing LIDAR signal. When the light source 10 includes a modulator, the light source controller 63 can operate the modulator so as to achieve the desired frequency versus time pattern in light signals that include light from the outgoing LIDAR signal.

The LIDAR chip can optionally include a control branch for controlling the operation of the light source 10. For instance, the control branch can provide a feedback loop that the light source controller 63 uses in operating the light source such that the outgoing LIDAR signal has the desired frequency versus time pattern.

The control branch includes a directional coupler 71 that moves a portion of the outgoing LIDAR signal from the utility waveguide 12 onto a control waveguide 72. The coupled portion of the outgoing LIDAR signal serves as a tapped signal. Although FIG. 1A illustrates a directional coupler 71 moving the portion of the outgoing LIDAR signal onto the control waveguide 72, other signal-taps can be used to move a portion of the outgoing LIDAR signal from the utility waveguide 12 onto the control waveguide 72. Examples of suitable signal taps include, but are not limited to, Y-junctions, and MMIs.

The control waveguide 72 carries the tapped signal to a feedback system 73. The feedback system 73 can include one or more light sensors (not shown) that convert light signals carried by the feedback system 73 to electrical signals that are output from the feedback system 73. The light source controller 63 can receive the electrical signals output from the feedback system 73. During operation, the light source controller 63 can adjust the frequency of the outgoing LIDAR signal in response to output from the electrical signals output from the feedback system 73. An example of a suitable construction and operation of feedback system 73 and light source controller 63 is provided in U.S. patent application Ser. No. 16/875,987, filed on 16 May 2020, entitled “Monitoring Signal Chirp in LIDAR Output Signals,” and incorporated herein in its entirety; and also in U.S. patent application Ser. No. 17/244,869, filed on 29 Apr. 2021, entitled “Reducing Size of LIDAR System Control Assemblies,” and incorporated herein in its entirety.

Although FIG. 1A illustrates the electronics 62 as a component that is separate from the signal processor(s) 28, a portion of the electronics can be included in each of the signal processor(s) 28.

In FIG. 1A, the incoming LIDAR signal passes through the signal director 14. The signal director 14 may be a source of optical loss. This source of optical loss can be removed by moving a portion of the incoming LIDAR signal that serves as the comparative signal onto the comparative waveguide 26 before the incoming LIDAR signal reaches the signal director 14. As an example, FIG. 1B illustrates the LIDAR chip of FIG. 1A modified such that a splitter 24 is located along each of the alternate waveguides 16 between the signal director 14 and the port 18. The signal splitter extracts a portion of the outgoing LIDAR signal from the alternate waveguide to serve as a reference signal and also extracts at least a portion of the incoming LIDAR signal from the alternate waveguide to serve as a comparative signal. As a result, the comparative signal is extracted from the alternate waveguide 16 before the incoming LIDAR signal reaches the signal director 14.

A comparison of FIG. 1A and FIG. 1B shows that the LIDAR chip of FIG. 1B requires more signal processors 28 than the LIDAR chip of FIG. 1A. As will become evident below, increasing the required number of signal processors 28 increases the number of Analog-to-Digital Converters required by the LIDAR system. However, a common signal processor 28 can be used to reduce the number of Analog-to-Digital Converters. As an example, FIG. 1C illustrates the LIDAR chip of FIG. 1B modified such that each of the comparative waveguides 26 carries one of the comparative signals to a common signal processor 74. Additionally, each of the reference waveguide 32 carries one of the reference signals to the common signal processor 74.

A LIDAR system can include a LIDAR chip with multiple LIDAR cores 4 on a support 77. As an example, FIG. 2 illustrates a LIDAR chip that includes multiple different cores. The cores are each labeled coreₖ where k represents a core index k. Each of the LIDAR cores can be constructed as disclosed in the context of FIG. 1A through FIG. 1C or can have an alternate construction. Each of the LIDAR cores outputs a different LIDAR output signal. The LIDAR output signal output from the cores labeled coreₖ can be represented by S_{k,i} where i represents the alternate waveguide index. As a result, S_{k,i} is function of the alternate waveguide index i and the core index k. As an example, the LIDAR output signal represented by S_{k,i} is output from coreₖ and was received by alternate waveguide index i. Accordingly, the LIDAR output signal represented by S_{k,i} is output from coreₖ and carries channel C₁.

The LIDAR system can optionally include an optical component assembly 75 that receives the LIDAR output signals from different cores and outputs system output signals that each includes, consists of, or consists essentially of light from a different one of the LIDAR output signals. The optical component assembly 75 can be operated by an assembly controller 280 so as to steer the system output signals to different sample regions in the LIDAR system's field of view.

FIG. 2 illustrates an optical component assembly 75 that includes signal director 76 that receives each of the LIDAR output signal. The signal director 76 changes the direction that at least a portion of the LIDAR output signals are traveling and outputs each of the LIDAR output signal as a re-directed LIDAR output signal. Suitable signal directors 76 include, but are not limited to, convex lenses and concave mirrors. The optical component assembly 75 includes one or more beam directors 78 that receive the re-directed LIDAR output signals output from the signal director 76 as system output signals. The direction that the system output signals travel away from the LIDAR system is labeled d₂ in FIG. 2. The assembly controller 280 can operate the one or more beam directors 78 so as to steer the each of the system output signal to different sample regions in a field of view. As is evident from the arrows labeled A and B in FIG. 2, the one or more beam directors 78 can be configured such that the assembly controller 280 can steer the system output signals in one dimension or in two dimensions. As a result, the one or more beam directors 78 can function as a beam-steering mechanism that is operated by the assembly controller 280 so as to steer the system output signals within the field of view of the LIDAR system. Suitable beam directors 78 include, but are not limited to, movable mirrors, MEMS mirrors, optical phased arrays (OPAs), optical gratings, and actuated optical gratings. In some instances, the signal director 76 and/or the one or more beam directors 78 are configured to operate on the system output signals such that the system output signals are collimated or substantially collimated as they travel away from the LIDAR system. Additionally or alternately, the LIDAR system can include one or more optical collimators (not illustrated) that operate on the LIDAR output signals, re-directed LIDAR output signals, and/or the system output signals such that the system output signals are collimated or substantially collimated as they travel away from the LIDAR system.

The system output signals can be reflected by an object located outside of the LIDAR system. All or a portion of the reflected light from a system output signal can return to the LIDAR system as a system return signal. Each of the system return signals is received at the one or more beam directors 78. The one or more beam directors 78 output at least a portion of each of the system return signals as a returned signal. The returned signals are each received at the signal director 76. The signal director 76 outputs at least a portion of each one of the retuned signals as a LIDAR input signal. Each of the different LIDAR input signals is received by a different one of the cores 4. Each of the LIDAR input signals includes or consists of light from the LIDAR output signal that was output from the core that receives the LIDAR input signal. Additionally, the LIDAR input signal received at an alternate waveguide includes or consists of the light from the LIDAR output signal that was output from the same alternate waveguide.

The one or more signal directors 76 can change the direction that a LIDAR output signal travels away from the one or more signal directors 76 such that the direction of a LIDAR output signal is different from the resulting re-directed LIDAR output signal. In some instances, the one or more signal directors 76 are selected such that all or a portion of the re-directed LIDAR output signal travel away from the one or more signal directors 76 in non-parallel directions. As an example, in FIG. 2, the one or more signal directors 76 is a lens and each of the different LIDAR output signals is incident on the lens at a different angle of incidence. As a result, the re-directed LIDAR output signals each travels away from the signal director 76 in a different direction. Further, the re-directed LIDAR output signals travel away from the signal director 76 in non-parallel directions. As is evident from FIG. 2, the different directions of the system output signals can result in the system output signals traveling away from the LIDAR system in different directions. In some instances, the system output signals travel away from the LIDAR system in non-parallel directions.

Operating the signal director 14 on a core can change where the LIDAR output signal is received by the one or more signal directors 76 and can accordingly change the direction that the system output signal that originates from that core travels away from the LIDAR system. As an example, the dashed line in FIG. 2 illustrates the result of operating the signal director 14 on core₁ such that the core outputs the LIDAR output signal represented by S_{k,i}+1 rather than the LIDAR output signal represented by Ski. As is evident from FIG. 2, this operation of the signal director 14 changes the direction that the system output signal output from core₁ travels away from the LIDAR system. As a result, the electronics 62 associated with different cores can operate the associated signal director 14 so as to steer the system output signals within the LIDAR system's field of view. For instance, the director controllers 15 associated with different cores can operate the associated signal directors 14 so as to steer the system output signals within the LIDAR system's field of view. Accordingly, the electronics 62 associated with different cores can operate the associated signal directors 14 so as to steer the system output signals within the LIDAR system's field of view and/or the assembly controller 280 can operate the one or more beam directors 78 so as to steer the system output signals within the LIDAR system's field of view. A suitable method of operating the signal directors 14 on different cores and/or the one or more beam directors 78 so as to steer the system output signals to different sample regions within the LIDAR system's field of view is disclosed in U.S. patent application Ser. No. 17/580,623, filed on Jan. 20, 2022, entitled “Imaging System Having Multiple Cores,” and incorporated herein in its entirety.

The optical component assembly 75 can have configurations other than the configuration shown in FIG. 2. For instance, the one or more beam directors 78 can be positioned between the signal director 76 and the LIDAR chip. Additionally, the optical component assembly 75 can include optical components that are not illustrated. For instance, the optical component assembly 75 can include one or more lenses configured to increase collimation of the LIDAR output signals and/or other signals derived from the LIDAR output signals and/or that include light from the LIDAR output signals.

The wavelength of the LIDAR output signal output from different cores can be same or different. As a result, the light source on different cores can be configured to output an outgoing light signal that each has a selection of wavelength that is different, the same or substantially the same. Accordingly, the selection of wavelengths in different system output signals can be different, the same or substantially the same.

Although FIG. 2 illustrates four cores on the LIDAR chip, the LIDAR chip can include one, two, or more than two cores. Suitable numbers of cores on the LIDAR chip, include, but are not limited to, numbers greater than or equal to 2, 4, or 6 and/or less than 32, 64, or 128.

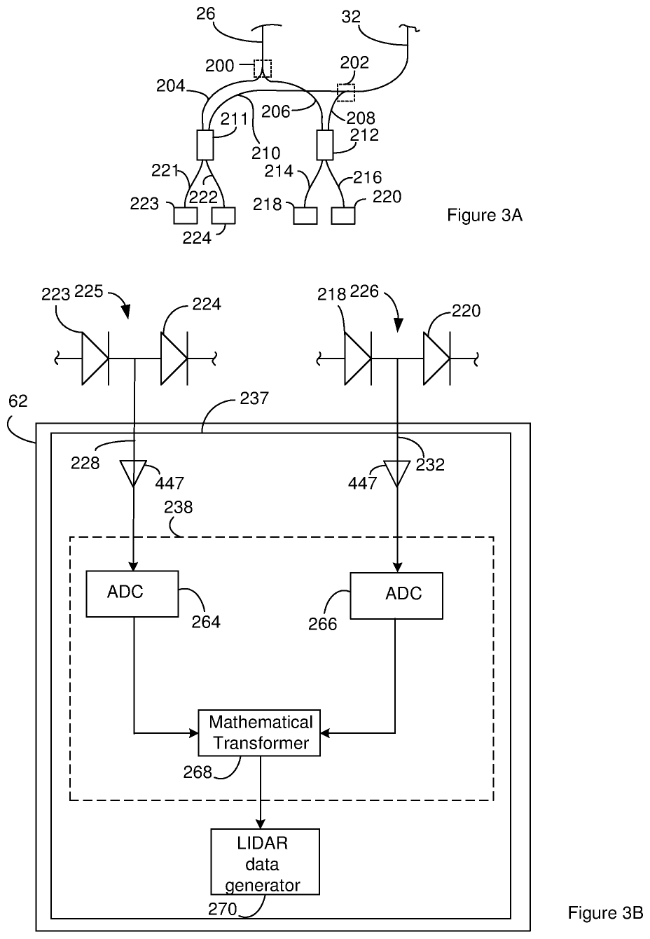

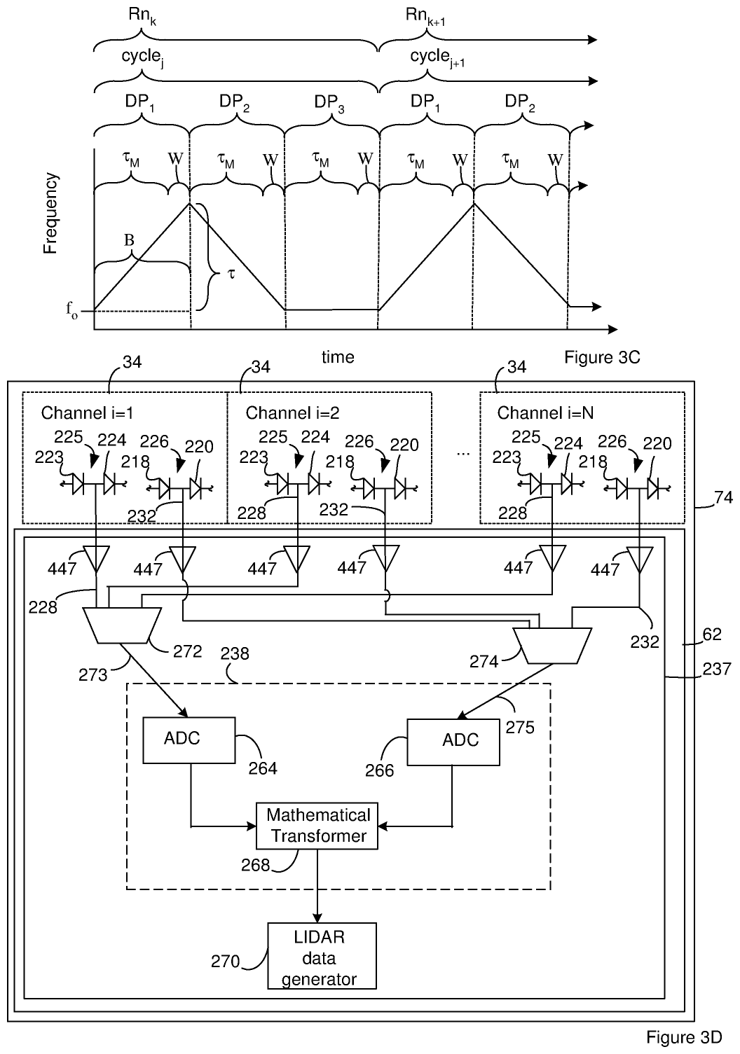

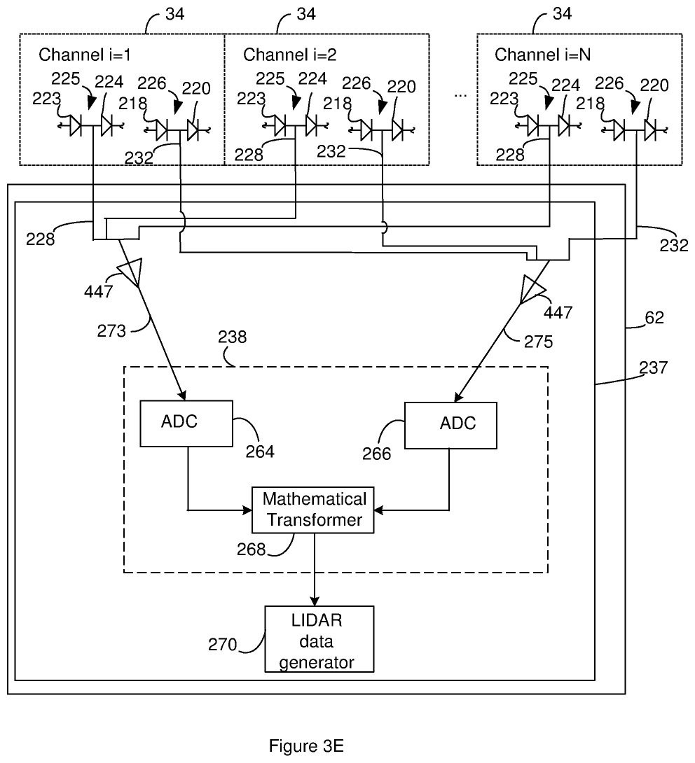

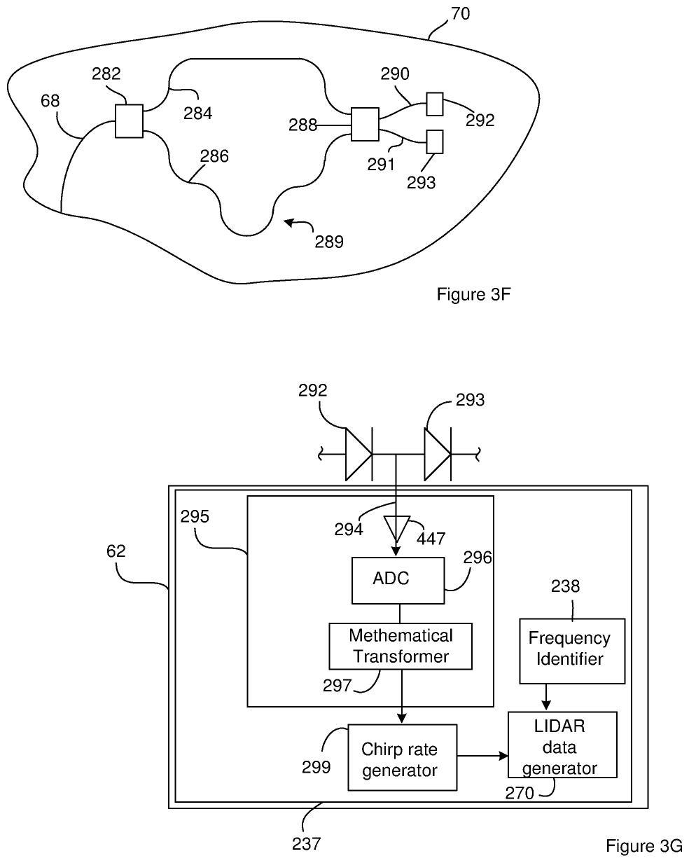

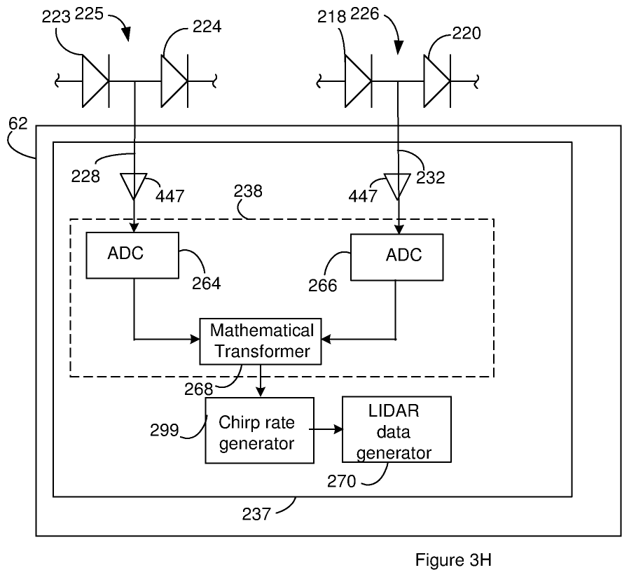

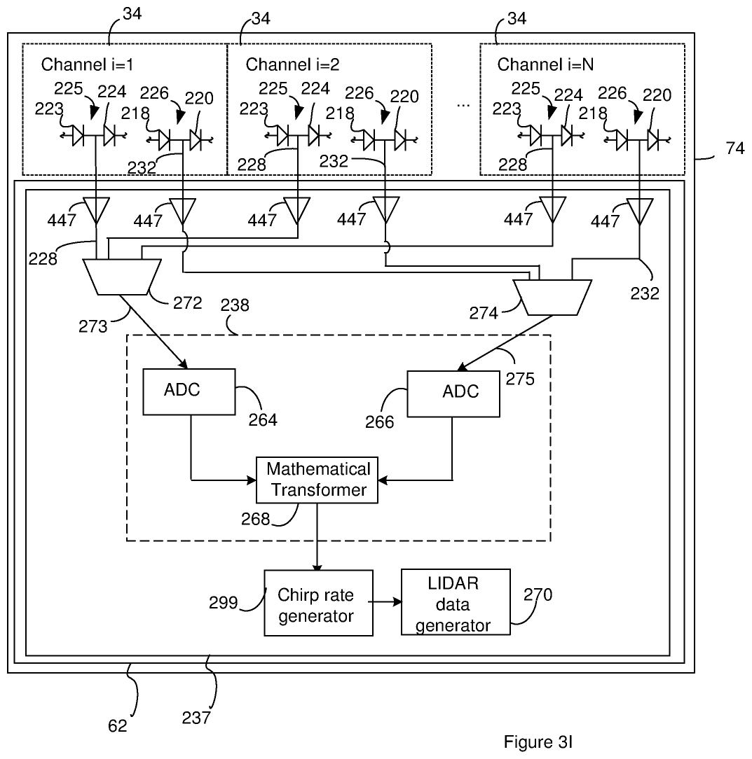

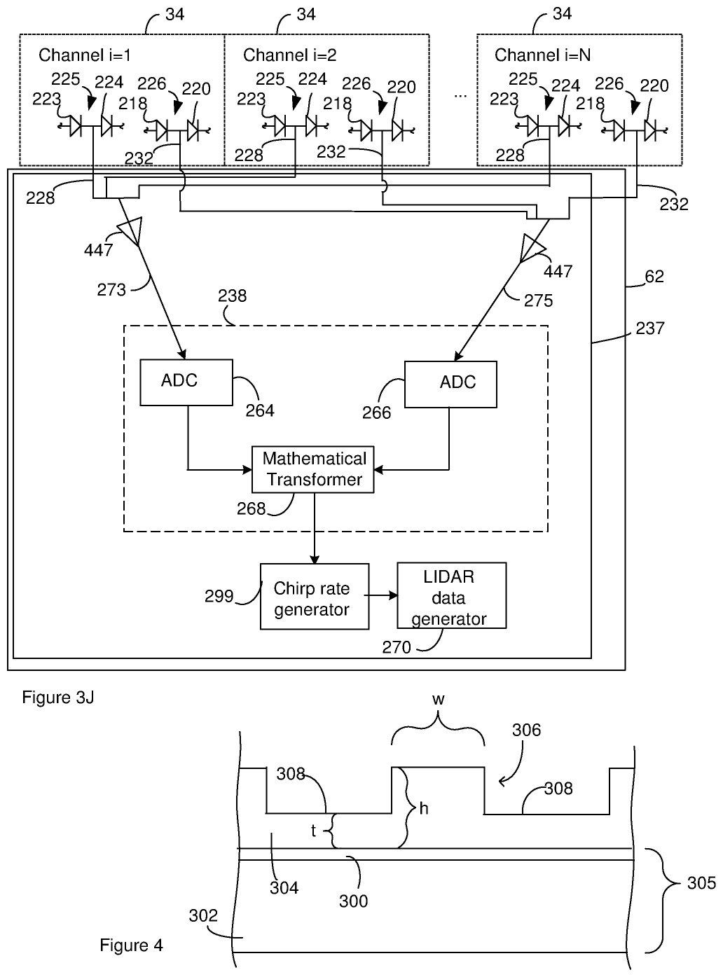

FIG. 3A through FIG. 3B illustrate an example of a signal processor that is suitable for use as the signal processor 28 in a LIDAR system constructed according to FIG. 1A and FIG. 1B. The signal processor includes an optical-to-electrical assembly configured to convert the light signals to electrical signals. FIG. 3A is a schematic of an example of a suitable optical-to-electrical assembly that includes a first splitter 200 that divides the comparative signal received from the comparative waveguide 26 onto a first comparative waveguide 204 and a second comparative waveguide 206. The first comparative waveguide 204 carries a first portion of the comparative signal to a light signal combiner 211. The second comparative waveguide 206 carries a second portion of the comparative signal to a second light signal combiner 212.

The signal processor of FIG. 3A also includes a second splitter 202 that divides the reference signal received from the reference waveguide 32 onto a first reference waveguide 210 and a second reference waveguide 208. The first reference waveguide 210 carries a first portion of the reference signal to the light signal combiner 211. The second reference waveguide 208 carries a second portion of the reference signal to the second light signal combiner 212.

The second light signal combiner 212 combines the second portion of the comparative signal and the second portion of the reference signal into a second composite signal. Due to the difference in frequencies between the second portion of the comparative signal and the second portion of the reference signal, the second composite signal is beating between the second portion of the comparative signal and the second portion of the reference signal. The first composite signal and the second composite signal are each an example of a composite signal.

The second light signal combiner 212 also splits the resulting second composite signal onto a first auxiliary detector waveguide 214 and a second auxiliary detector waveguide 216. The first auxiliary detector waveguide 214 carries a first portion of the second composite signal to a first auxiliary light sensor 218 that converts the first portion of the second composite signal to a first auxiliary electrical signal. The second auxiliary detector waveguide 216 carries a second portion of the second composite signal to a second auxiliary light sensor 220 that converts the second portion of the second composite signal to a second auxiliary electrical signal. Examples of suitable light sensors include germanium photodiodes (PDs), and avalanche photodiodes (APDs).

In some instances, the second light signal combiner 212 splits the second composite signal such that the portion of the comparative signal (i.e. the portion of the second portion of the comparative signal) included in the first portion of the second composite signal is phase shifted by 180° relative to the portion of the comparative signal (i.e. the portion of the second portion of the comparative signal) in the second portion of the second composite signal but the portion of the reference signal (i.e. the portion of the second portion of the reference signal) in the second portion of the second composite signal is not phase shifted relative to the portion of the reference signal (i.e. the portion of the second portion of the reference signal) in the first portion of the second composite signal. Alternately, the second light signal combiner 212 splits the second composite signal such that the portion of the reference signal (i.e. the portion of the second portion of the reference signal) in the first portion of the second composite signal is phase shifted by 180° relative to the portion of the reference signal (i.e. the portion of the second portion of the reference signal) in the second portion of the second composite signal but the portion of the comparative signal (i.e. the portion of the second portion of the comparative signal) in the first portion of the second composite signal is not phase shifted relative to the portion of the comparative signal (i.e. the portion of the second portion of the comparative signal) in the second portion of the second composite signal. Examples of suitable light sensors include germanium photodiodes (PDs), and avalanche photodiodes (APDs).

The first light signal combiner 211 combines the first portion of the comparative signal and the first portion of the reference signal into a first composite signal. Due to the difference in frequencies between the first portion of the comparative signal and the first portion of the reference signal, the first composite signal is beating between the first portion of the comparative signal and the first portion of the reference signal.

The light signal combiner 211 also splits the first composite signal onto a first detector waveguide 221 and a second detector waveguide 222. The first detector waveguide 221 carries a first portion of the first composite signal to a first light sensor 223 that converts the first portion of the second composite signal to a first electrical signal. The second detector waveguide 222 carries a second portion of the second composite signal to a second light sensor 224 that converts the second portion of the second composite signal to a second electrical signal. Examples of suitable light sensors include germanium photodiodes (PDs), and avalanche photodiodes (APDs).

In some instances, the light signal combiner 211 splits the first composite signal such that the portion of the comparative signal (i.e. the portion of the first portion of the comparative signal) included in the first portion of the composite signal is phase shifted by 180° relative to the portion of the comparative signal (i.e. the portion of the first portion of the comparative signal) in the second portion of the composite signal but the portion of the reference signal (i.e. the portion of the first portion of the reference signal) in the first portion of the composite signal is not phase shifted relative to the portion of the reference signal (i.e. the portion of the first portion of the reference signal) in the second portion of the composite signal. Alternately, the light signal combiner 211 splits the composite signal such that the portion of the reference signal (i.e. the portion of the first portion of the reference signal) in the first portion of the composite signal is phase shifted by 180° relative to the portion of the reference signal (i.e. the portion of the first portion of the reference signal) in the second portion of the composite signal but the portion of the comparative signal (i.e. the portion of the first portion of the comparative signal) in the first portion of the composite signal is not phase shifted relative to the portion of the comparative signal (i.e. the portion of the first portion of the comparative signal) in the second portion of the composite signal.

When the second light signal combiner 212 splits the second composite signal such that the portion of the comparative signal in the first portion of the second composite signal is phase shifted by 180° relative to the portion of the comparative signal in the second portion of the second composite signal, the light signal combiner 211 also splits the composite signal such that the portion of the comparative signal in the first portion of the composite signal is phase shifted by 180° relative to the portion of the comparative signal in the second portion of the composite signal. When the second light signal combiner 212 splits the second composite signal such that the portion of the reference signal in the first portion of the second composite signal is phase shifted by 180° relative to the portion of the reference signal in the second portion of the second composite signal, the light signal combiner 211 also splits the composite signal such that the portion of the reference signal in the first portion of the composite signal is phase shifted by 180° relative to the portion of the reference signal in the second portion of the composite signal.

An example of a suitable light signal combiner 211 and second light signal combiner 212 is a Multi-Mode Interference (MMI) device such as a 2×2 MMI device. Other suitable light signal combiners for use as the light signal combiner 211 and second light signal combiner 212 include, but are not limited to, adiabatic splitters, and directional coupler. In some instances, the functions of the illustrated light signal combiners are performed by more than one optical component or a combination of optical components.

The first reference waveguide 210 and the second reference waveguide 208 are constructed to provide a phase shift between the first portion of the reference signal and the second portion of the reference signal. For instance, the first reference waveguide 210 and the second reference waveguide 208 can be constructed so as to provide a 90 degree phase shift between the first portion of the reference signal and the second portion of the reference signal. As an example, one reference signal portion can be an in-phase component and the other a quadrature component. Accordingly, one of the reference signal portions can be a sinusoidal function and the other reference signal portion can be a cosine function. In one example, the first reference waveguide 210 and the second reference waveguide 208 are constructed such that the first reference signal portion is a cosine function and the second reference signal portion is a sine function. Accordingly, the portion of the reference signal in the second composite signal is phase shifted relative to the portion of the reference signal in the first composite signal, however, the portion of the comparative signal in the first composite signal is not phase shifted relative to the portion of the comparative signal in the second composite signal.

The first light sensor 223 and the second light sensor 224 can be connected as a balanced detector and the first auxiliary light sensor 218 and the second auxiliary light sensor 220 can also be connected as a balanced detector. The balanced detector(s) serve as light sensors that convert a light signal to an electrical signal. FIG. 3B provides a schematic of the relationship between the electronics 62, the first light sensor 223, the second light sensor 224, the first auxiliary light sensor 218, and the second auxiliary light sensor 220. The symbol for a photodiode is used to represent the first light sensor 223, the second light sensor 224, the first auxiliary light sensor 218, and the second auxiliary light sensor 220 but one or more of these sensors can have other constructions. In some instances, all of the components illustrated in the schematic of FIG. 3B are included on the LIDAR chip. In some instances, the components illustrated in the schematic of FIG. 3B are distributed between the LIDAR chip and electronics 62 located off of the LIDAR chip.

The electronics 62 connect the first light sensor 223 and the second light sensor 224 as a first balanced detector 225 and the first auxiliary light sensor 218 and the second auxiliary light sensor 220 as a second balanced detector 226. In particular, the first light sensor 223 and the second light sensor 224 are connected in series. Additionally, the first auxiliary light sensor 218 and the second auxiliary light sensor 220 are connected in series. The serial connection in the first balanced detector is in communication with a first data line 228 that carries the output from the first balanced detector as a first data signal. The serial connection in the second balanced detector is in communication with a second data line 232 that carries the output from the second balanced detector as a second data signal. The first data line and the second data line are each an example of a data line. The first data signal is an electrical data signal that carries a representation of the first composite signal and the second data signal is an electrical data signal that carries a representation of the second composite signal. Accordingly, the first data signal includes a contribution from a first waveform and a second waveform and the second data signal is a composite of the first waveform and the second waveform. The portion of the first waveform in the first data signal is phase-shifted relative to the portion of the first waveform in the first data signal but the portion of the second waveform in the first data signal being in-phase relative to the portion of the second waveform in the first data signal. For instance, the second data signal includes a portion of the reference signal that is phase shifted relative to a different portion of the reference signal that is included the first data signal. Additionally, the second data signal includes a portion of the comparative signal that is in-phase with a different portion of the comparative signal that is included in the first data signal. The first data signal and the second data signal are beating as a result of the beating between the comparative signal and the reference signal, i.e. the beating in the first composite signal and in the second composite signal.

The electronics 62 includes a data processor 237 configured to generate the LIDAR data. The data processor 237 includes a beat frequency identifier 238 configured to identify the beat frequency of the composite signal from the first data signal and the second data signal. The beat frequency identifier 238 receives the first data signal and the second data signal. Since the first data signal is an in-phase component and the second data signal its quadrature component, the first data signal and the second data signal together act as a complex data signal where the first data signal is the real component and the second data signal is the imaginary component of the complex data signal.

The data processor 237 includes a first Analog-to-Digital Converter (ADC) 264 that receives the first data signal from the first data line 228. The first Analog-to-Digital Converter (ADC) 264 converts the first data signal from an analog form to a digital form and outputs a first digital data signal. The beat frequency identifier 238 includes a second Analog-to-Digital Converter (ADC) 266 that receives the second data signal from the second data line 232. The second Analog-to-Digital Converter (ADC) 266 converts the second data signal from an analog form to a digital form and outputs a second digital data signal. The first digital data signal is a digital representation of the first data signal and the second digital data signal is a digital representation of the second data signal. Accordingly, the first digital data signal and the second digital data signal act together as a complex signal where the first digital data signal acts as the real component of the complex signal and the second digital data signal acts as the imaginary component of the complex data signal.

The beat frequency identifier 238 includes a mathematical transformer 268 that receives the complex data signal. For instance, the mathematical transformer 268 receives the first digital data signal from the first Analog-to-Digital Converter (ADC) 264 as an input and also receives the second digital data signal from the first Analog-to-Digital Converter (ADC) 266 as an input. The mathematical transformer 268 can be configured to perform a mathematical transform on the complex signal so as to convert from the time domain to the frequency domain. The mathematical transform can be a complex transform such as a complex Fast Fourier Transform (FFT). A complex transform such as a complex Fast Fourier Transform (FFT) provides an unambiguous solution for the shift in frequency of a comparative signal relative to the system output signal.

The mathematical transformer 268 can include a peak finder (not shown) configured to identify peaks in the output of the mathematical transformer 268. The peak finder can be configured to identify any frequency peaks associated with reflection of the system output signal by one or more objects located outside of the LIDAR system. For instance, frequency peaks associated with reflection of the system output signal by one or more objects located outside of the LIDAR system can fall within a frequency range. The peak finder can identify the frequency peak within the range of frequencies associated with the reflection of the system output signal by one or more objects located outside of the LIDAR system. The frequency of the identified frequency peak represents the beat frequency of the composite signal.

The data processor 237 includes a LIDAR data generator 270 that receives the beat frequency of the composite signal from the peak finder. The LIDAR data generator 270 processes the beat frequency of the composite signal so as to generate the LIDAR data (distance and/or radial velocity between the reflecting object and the LIDAR chip or LIDAR system).

FIG. 3C shows an example of a relationship between the frequency of the system output signal, time, cycles and data periods. The base frequency of the system output signal (fₒ) can be the frequency of the system output signal at the start of a cycle.

FIG. 3C shows frequency versus time pattern for a sequence of two cycles labeled cycleⱼ and cycledⱼ₊₁ where j represents a cycle index. In some instances, the frequency versus time pattern is repeated in each cycle as shown in FIG. 3C. The illustrated cycles do not include re-location periods and/or re-location periods are not located between cycles. As a result, FIG. 3C illustrates the results for a continuous scan where the steering of the system output signal is continuous.

Each cycle includes K data periods that are each associated with a period index n and are labeled DPₙ. In the example of FIG. 3C, each cycle includes three data periods labeled DPₙ with n=1, 2, and 3. In some instances, the frequency versus time pattern is the same for the data periods that correspond to each other in different cycles as is shown in FIG. 3C. Corresponding data periods are data periods with the same period index. As a result, each data period DP₁ can be considered corresponding data periods and the associated frequency versus time patterns are the same in FIG. 3C. At the end of a cycle, the light source controller 63 returns the frequency to the same frequency level at which it started the previous cycle.

During the data period DP₁, and the data period DP₂, the light source controller 63 operates the light source such that the frequency of the system output signal changes at a linear target chirp rate tan where n represents the period index. Calculation of the target chirp rate for one of the data periods labeled DP₁ is illustrated in FIG. 3C. For instance, the duration of the data period is labeled τ and the magnitude of the frequency change during the data period is labeled B. The target chirp rate tai can be determined from t_{α1}=B/τ.

The target chirp rate can be different for different data periods. For instance, in FIG. 3C, the direction of the target chirp rate during the data periods DP₁ is the opposite of the direction of the target chirp rate during the data periods DP₂. However, the magnitude of the target chirp rate during the data period DP₁ is the same as the magnitude of the target chirp rate during the data period DP₂. As a result, t_{α1}=−t_{α2}.

The electronics 62 are configured to provide the same target chirp rate for data periods with the same period index. For instance, each of the data periods associated with period index n=1 has a target chirp rate equal to α₁. However, as time passes and the number of cycles increases, the actual chirp rate (αₙ) produced becomes less reliable. When the target chirp rate is used to calculate LIDAR data for each of the sample regions, the difference between the actual chirp rate (αₙ) and the target chirp rate (tan) becomes a source of error in the LIDAR data.

FIG. 3C labels sample regions that are each associated with a sample region index k and are labeled Rnₖ. FIG. 3C labels sample regions Rnₖ and Rnₖ₊₁. Each sample region is illuminated with the system output signal during the data periods that FIG. 3C shows as associated with the sample region. For instance, sample region Rnₖ is illuminated with the system output signal during the data periods labeled DP₁ through DP₃. The sample region indices k can be assigned relative to time. For instance, the sample regions can be illuminated by the system output signal in the sequence indicated by the index k. As a result, the sample region Rn₁₀ can be illuminated after sample region Rn₉ and before Rn₁₁.

Different sample regions and/or different cycles can be associated with different channels. For instance, each of the sample regions can be illuminated by a system output signal that carries the same channel during each of the data periods associated with the sample region. Additionally, different sample regions can be illuminated by a system output signal carrying a different one of the channels. Accordingly, the director controller 15 can operate the signal director 14 so as direct light from the light source output signal to a different one of the alternate waveguides 16 at or between a change to a different cycle and/or at or between a change to a different sample region.

The LIDAR system is typically configured to provide reliable LIDAR data when the object is within an operational distance range from the LIDAR system. The operational distance range can extend from a minimum operational distance to a maximum operational distance. A maximum roundtrip time can be the time required for a system output signal to exit the LIDAR system, travel the maximum operational distance to the object, and to return to the LIDAR system and is labeled τM in FIG. 3C.

Since there is a delay between the system output signal being transmitted and returning to the LIDAR system, the composite signals do not include a contribution from the LIDAR signal until after the system return signal has returned to the LIDAR system. Since the composite signal needs the contribution from the system return signal for there to be a beat frequency, the beat frequency identifier 238 outputs the beat frequency of the composite signal that results from system return signal that return to the LIDAR system during a data window in the data period. The data window is labeled “W” in FIG. 3C. The contribution from the LIDAR signal to the composite signals will be present at times larger than the maximum operational time delay (cm). As a result, the data window is shown extending from the maximum operational time delay (cm) to the end of the data period.

A frequency peak in the output from the Complex Fourier transform represents the beat frequency of the composite signals that each includes a comparative signal beating against a reference signal. The beat frequencies from two or more different data periods can be combined to generate the LIDAR data. For instance, the beat frequency determined from DP₁ in FIG. 3C can be combined with the beat frequency determined from DP₂ in FIG. 3C to determine the LIDAR data. As an example, the following equation applies during a data period where the frequency of the outgoing LIDAR signal increases during the data period such as occurs in data period DP₁ of FIG. 3C: f_{ub}=−f_{d}+α_{nτ} where f_{ub} is the frequency provided by the mathematical transformer, ƒ_{d} represents the Doppler shift (f_{d}=2vf_{c}/c) where f_{c} represents the optical frequency (fₒ), c represents the speed of light, ν is the radial velocity between the reflecting object and the LIDAR system where the direction from the reflecting object toward the chip is assumed to be the positive direction, τ is the time in which the light from the system output signal travels to the object and returns to the LIDAR system (the roundtrip time), and c is the speed of light. Additionally, an represents the chirp rate during the data period with period index n. For instance, α₁ represents the chirp rate during the same data period DP₁ that resulted in the f_{ub} being provided by the mathematical transformer. As a result, αₙ and f_{ub} are associated with the same data period DPₙ.

The following equation applies during a data period where the frequency of the outgoing LIDAR signal decreases such as occurs in data period DP₂ of FIG. 3C: f_{db}=−f_{d}−α_{nτ} where f_{db} is a frequency provided by the mathematical transformer (f_{i,LDP} determined from DP₂ in this case). Additionally, αₙ represents the chirp rate during the data period with period index n. For instance, α₂ represents the chirp rate during the same data period DP₂ that resulted in the f_{ub} being provided by the mathematical transformer. As a result, αₙ and f_{ub} are associated with the same data period DPₙ.

In these two equations (f_{db}, =−f_{d}−α_{nτ} and f_{ub}=−f_{d}+α_{nτ}), ƒ_{d} and τ are unknowns. These equations can be solved for these two unknowns. The LIDAR data generator can calculate the radial velocity for the sample region from the Doppler shift (ν=c*f_{d}/(2f_{c})) and/or the separation distance for that sample region from c*τ/2. For instance, when the system output signal has a frequency versus time pattern as shown in FIG. 3C, the distance between the LIDAR system and an object external to the LIDAR system (r) can be calculated from r=c(f_{ub}−f_{db})/(2(α₁−α₂)) and the radial velocity between the LIDAR system and the object can be calculated from ν=c(α₂f_{ub}−α₁f_{db})/(2f_{c}(α₁−α₂)). Accordingly, the calculated chirp rate (α₁) and the calculated composite signal beat frequency is a variable in equations that the LIDAR data generator uses to calculate the LIDAR data. Additionally, the LIDAR data generator 270 can combine the chirp rates (αₙ) and beat frequencies from different data periods so as to calculate the LIDAR data for a sample region. Since the LIDAR data can be generated for each corresponding frequency pair output by the transform, separate LIDAR data can be generated for each of the objects in a sample region. Accordingly, the data processor 237 can determine more than one radial velocity and/or more than one radial separation distance from a single sampling of a single sample region in the field of view.

The data period labeled DP₃ in FIG. 3C is optional. As noted above, there are situations where more than one object is present in a sample region. For instance, during the feedback period in DP₁ for cycle₂ and also during the feedback period in DP₂ for cycle₂, more than one frequency pair can be matched. In these circumstances, it may not be clear which frequency peaks from DP₂ correspond to which frequency peaks from DP₁. As a result, it may be unclear which frequencies need to be used together to generate the LIDAR data for an object in the sample region. As a result, there can be a need to identify corresponding frequencies. The identification of corresponding frequencies can be performed such that the corresponding frequencies are frequencies from the same reflecting object within a sample region. The data period labeled DP₃ can be used to find the corresponding frequencies. LIDAR data can be generated for each pair of corresponding frequencies and is considered and/or processed as the LIDAR data for the different reflecting objects in the sample region.

An example of the identification of corresponding frequencies uses a LIDAR system where the cycles include three data periods (DP₁, DP₂, and DP₃) as shown in FIG. 3C. When there are two objects in a sample region illuminated by the LIDAR outputs signal, the mathematical transformer outputs two different frequencies for f_{ub}: fᵤ₁ and fᵤ₂ during DP₁ and another two different frequencies for f_{db}: f_{d1} and f_{d2} during DP₂. In this instance, the possible frequency pairings are: (f_{d1}, fᵤ₁); (f_{d1}, fᵤ₂); (f_{d2}, fᵤ₁); and (f_{d2}, f_{du2}). A value of ƒ_{d} and τ can be calculated for each of the possible frequency pairings. Each pair of values for ƒ_{d} and τ can be substituted into ƒ₃=−ƒ_{d}+α₃τ₀ to generate a theoretical ƒ₃ for each of the possible frequency pairings. The value of α₃ is different from the value of a used in DP₁ and DP₂. In FIG. 3C, the value of α₃ is zero. In this case, the mathematical transformer also outputs two values for ƒ₃ that are each associated with one of the objects in the sample region. The frequency pair with a theoretical ƒ₃ value closest to each of the actual ƒ₃ values is considered a corresponding pair. LIDAR data can be generated for each of the corresponding pairs as described above and is considered and/or processed as the LIDAR data for a different one of the reflecting objects in the sample region. Each set of corresponding frequencies can be used in the above equations to generate LIDAR data. The generated LIDAR data will be for one of the objects in the sample region. As a result, multiple different LIDAR data values can be generated for a sample region where each of the different LIDAR data values corresponds to a different one of the objects in the sample region

The signal processor in FIG. 1A receives a series of comparative signals that carry different channels and are accordingly from different sample regions. As a result, the signal processors in FIG. 1A provide LIDAR data for series of sample regions that were illuminated by system output signals carrying different channels. The series of sample regions for which the signal processor provides LIDAR data can be the same as the series of sample regions that were illuminated. The signal processor configuration of FIG. 3A through FIG. 3C can also be used for the signal processors of FIG. 1B. However, the signal processors 28 of FIG. 1B receive comparative signals that carry only one of the channels. As a result, when the signal processors 28 in FIG. 1B are constructed according to FIG. 3A through FIG. 3C, each of the signal processors provides LIDAR data for a series of sample regions that were illuminated by the system output signal carrying only one of the channels.

In the LIDAR system of FIG. 1C, the components from different signal processors 28 can be combined so that beating signals are combined electronically rather than optically. For instance, each of the signal processors 28 in a LIDAR system according to FIG. 1C can include the optical-to-electrical assembly of FIG. 3A. FIG. 3D is a schematic of the relationship between the first light sensor 223, the second light sensor 224, the first auxiliary light sensor 218, and the second auxiliary light sensor 220 in each of the optical-to-electrical assemblies from FIG. 3A and the electronics. Since each of the different signal processors 28 receives a LIDAR input signal carrying a different channel, FIG. 3D illustrates the first light sensor 223, the second light sensor 224, the first auxiliary light sensor 218, and the second auxiliary light sensor 220 associated with the channel received by the light sensor.

In FIG. 3D, the components from different signal processors 28 (FIG. 1C) are combined so as to form the common signal processor 74. The first data line 228 from each of the different first balanced detectors 225 carries the first data signal to a first electrical multiplexer 272. The first electrical multiplexer 272 outputs the first data signals from different first data lines 228 on a common data line 273. Since system output signals that are from the same core and that carry different channels are serially output from the LIDAR system, the signal processor 28 (FIG. 1C) configured to receive the first comparative signal carrying channel i receives the first comparative signal in response to the signal director 14 on the core being operated such that the system output signal carrying channel i is output from the LIDAR system. Additionally, signal processor(s) 28 that are not configured to receive the comparative signal carrying channel i do not substantially receive a first comparative signal in response to the signal director 14 being operated such that the system output signal carrying channel i is output from the LIDAR system. Since the system output signals that carry different channels from the same core are serially output from the LIDAR system, the comparative signals carrying different channels are serially received at different signal processor(s) 28 although there may be some overlap of different channels that occurs. Since different signal processor(s) 28 serially receive the comparative signals carrying different channels, the first common data line 273 carries first data signals that carry different channels in series. Accordingly, the first common data line 273 carries electrical data signals that are each an electrical representation of the first composite signals and that each carries a different one of the channels in series. There may be some short term overlap between channels in the series of first data signals, however, the overlap does not occur in the data windows illustrated in FIG. 3C. The first common data line 273 carries the series of first data signals to the first Analog-to-Digital Converter (ADC) 264.

The second data lines 232 from each of the different second balanced detectors 226 carries the second data signal to a second electrical multiplexer 274. The second electrical multiplexer 274 outputs the second data signals from different second data line 232 on a second common data line 275. The first common data line and the second common data line are each an example of a common data line. As noted above, the signal processor(s) 28 serially receive the first comparative signals carrying different channels. As a result, the second common data line 275 carries second data signals that carry different channels in series. Accordingly, the second common data line 275 carries electrical data signals that are each an electrical representation of the second composite signals and that each carries a different one of the channels in series. There may be some short term overlap between channels in the series of second data signals, however, the overlap does not occur during the data windows illustrated in FIG. 3C. The second common data line 275 carries the series of second data signals to the second Analog-to-Digital Converter (ADC) 266.

The beat frequency identifier 238 and LIDAR data generator 270 of FIG. 3D can be operated as disclosed in the context of FIG. 3A through FIG. 3C. For instance, the first Analog-to-Digital Converter (ADC) 264 converts the first data signal from an analog form to a digital form and outputs the first digital data signal. The second Analog-to-Digital Converter (ADC) 266 converts the second data signal from an analog form to a digital form and outputs a second digital data signal.

A first digital data signal and the second digital data signal carrying the same channel act together as a complex signal where the first digital data signal acts as the real component of the complex signal and the second digital data signal acts as the imaginary component of the complex data signal. The first digital data signals and the second digital data signals carrying the same channel are concurrently received by the mathematical transformer 268. As a result, the mathematical transformer 268 receives complex signals that carry different channels in series. Accordingly, the LIDAR data generator 270 serially receives the beat frequencies of composite signals that carry different channels. As a result, the LIDAR data generator 270 can generate LIDAR data for each of the different channels. Accordingly, the LIDAR data generator 270 can generate LIDAR data for each sample region that is illuminated by the system output signals carrying the series of channels.

In another embodiment of a LIDAR system where the relationship between sensors in the optical-to-electrical assembly from FIG. 3A and electronics in the LIDAR system is constructed according to FIG. 3D, the data processor 237 operates the electrical multiplexers as a switch that can be operated by the electronics. As a result, the data processor 237 can operate the first electrical multiplexer 272 so as select which of the first data signals are output on the common data line 273 and can operate the second electrical multiplexer 274 so as select which of the second data signals are output on the second common data line 275. As a result, the LIDAR system can be configured to concurrently output the system output signals that carry different channels. For instance, the LIDAR chip can be configured to concurrently output each of the LIDAR output signals carrying the different channels. As a result, the signal director 14 can be configured to direct the outgoing LIDAR system to one or more than one of the alternate waveguides 16. In an example where the signal director 14 is configured to direct the outgoing LIDAR system all N of the alternate waveguides 16, the signal director can be a signal splitter.

When the LIDAR system concurrently outputs system output signals that carry different channels, each of the different signal processors 28 can concurrently receive a first LIDAR input signal carrying one of the channels. Accordingly, the first data lines 228 from each of the different signal processors 28 concurrently carries the first data signal to the first electrical multiplexer 272. As a result, the first electrical multiplexer 272 concurrently receives multiple first data signals that each carries a different channel and is from a different signal processor 28. The data processor 237 uses the switching functionality of the first electrical multiplexer 272 to operate the first electrical multiplexer 272 such that the first electrical multiplexer 272 outputs the first data signals carrying different channels in series. As a result, the first common data line 273 carries first data signals that carry different channels in series. An example of a suitable channel series, includes, but is not limited to, the sequence of channels having alternate waveguide index i=1 through N in the numerical sequence from i=1 through to i=N.

The second data lines 232 from each of the different signal processors 28 concurrently carries a second data signal to the second electrical multiplexer 274. As a result, the second electrical multiplexer 274 concurrently receives multiple second data signals that each carries a different channel and is from a different signal processor 28. The data processor 237 use the switching functionality of the second electrical multiplexer 274 to operate the second electrical multiplexer 274 such that the second electrical multiplexer 274 outputs the second data signals carrying different channels in series. As a result, the second data line 275 carries second data signals that carry different channels in series.

The beat frequency identifier 238 and LIDAR data generator 270 of FIG. 3D can be operated as disclosed in the context of FIG. 3A through FIG. 3C. For instance, the first Analog-to-Digital Converter (ADC) 264 converts the first data signal from an analog form to a digital form and outputs the first digital data signal. The second Analog-to-Digital Converter (ADC) 266 converts the second data signal from an analog form to a digital form and outputs a second digital data signal.

The first electrical multiplexer 272 and the second electrical multiplexer 274 are operated such that the first data line 273 and the second data line 275 concurrently carry the same channel. As a result, the first digital data signal and the second digital data signal output from the first Analog-to-Digital Converter (ADC) 264 and the second Analog-to-Digital Converter (ADC) 266 concurrently carry the same channel. The first digital data signal and the second digital data signal carrying the same channel act together as a complex signal where the first digital data signal acts as the real component of the complex signal and the second digital data signal acts as the imaginary component of the complex data signal. The first digital data signals and the second digital data signals carrying the same channel are concurrently received by the mathematical transformer 268. As a result, the mathematical transformer 268 receives complex signals that carry different channels in series. Accordingly, the LIDAR data generator 270 serially receives the beat frequencies of composite signals that carry different channels. As a result, the LIDAR data generator 270 can generate LIDAR data for each of the different channels. Accordingly, the LIDAR data generator 270 can generate LIDAR data for each sample region that is illuminated by the system output signals carrying the series of channels.

An alternative to the first electrical multiplexer 272 and/or the second electrical multiplexer 274 is to provide an electrical node where the first data lines 228 from each of the different first balanced detectors 225 are in electrical communication with one another and a second electrical node the second data lines 232 from each of the different second balanced detectors 226 are in electrical communication with one another. As a result, the outputs of the light sensors such as the first balanced detectors 225 are effectively electrically connected to one another and the outputs of light sensors such as the second balanced detectors 226 are effectively electrically connected to one another. As an example, FIG. 3E illustrates the arrangement of FIG. 3D modified such that the first data lines 228 from each of the different first balanced detectors 225 are in electrical communication with the first common data line 273. Since the LIDAR system outputs system output signals that carry different channels in series, the first common data line 273 carries first data signals that carry different channels in series. While there may be some overlap between channels that are adjacent to one another in the series, the overlap does not occur during the data window. Additionally, the second data lines 232 from each of the different second balanced detectors 226 are in electrical communication with the second common data line 275. Since the LIDAR system outputs system output signals that carry different channels in series, the second common data line 275 carries second data signals that carry different channels in series. While there may be some overlap between channels that are adjacent to one another in the series, the overlap does not occur during the data window. Since the first common data line 273 carries first data signals that carry different channels in series and the second common data line 275 carries second data signals that carry different channels in series as also occurs in the LIDAR system of FIG. 3D, the beat frequency identifier 238 and LIDAR data generator 270 can be operated as disclosed in the context of FIG. 3E to generate LIDAR data for each sample region that is illuminated by the system output signals carrying the series of channels.

In a LIDAR system constructed according to FIG. 3E, during a cycle when the LIDAR system is outputting a system output signal that carries channel i, the optical-to-electrical assembly included in the signal processor configured to receive the current channel i (the active signal processor) receives the first LIDAR input signals that carries channel i during at least the data window while the signal processor that are not configured to receive the current channel i (the inactive signal processor(s)) do not receive a first LIDAR input signal. However, the inactive signal processor(s) continue to receive a reference signal during at least the data window. Light from the reference signal(s) received by the inactive signal processor(s) can pass through the optical-to-electrical assemblies and become noise in electrical signals such as the first data signals and the second data signals.

In some instances, it may be desirable to fully or partially attenuate all or a portion of the reference signal(s) received by the inactive signal processor(s). For instance, the reference waveguides 32 (FIG. 1C) can each optionally include an optical attenuator 276. The attenuators 276 can be operated by the electronics 62 so as to fully or partially attenuate the reference signal guided by the reference waveguide 32 along which the attenuator 276 is positioned.

The signal processor labeled 28 in FIG. 1C that serves as the active signal processor and the signal processor(s) labeled 28 in FIG. 1C that serve as the inactive signal processor(s) changes as the channel carried by the system output signal changes. As a result, the electronics 62 can change the reference signal(s) that are attenuated in response to changes in the channel that is currently being carried in the system output signal. For instance, the electronics 62 can operate the attenuators 276 such that the reference signal to be received by an active signal processor is not attenuated or is not substantially attenuated. Additionally, the electronics 62 can operate the attenuators 276 such that the reference signal(s) to be received by all or a portion of the inactive signal processor(s) is fully or partially attenuated. Since the reference signal(s) to be received by all or a portion of the inactive signal processor(s) is fully or partially attenuated, the amount of light from the reference signals that is actually received by the inactive signal processor(s) is reduced. As a result, the attenuated light is not a source of noise in the first data signal and the second data signal.

Although the optical attenuators 276 are shown positioned on the reference waveguides 32 of FIG. 1C, the optical attenuators 276 can be positioned on all or a portion of the reference waveguides 32 illustrated in the imaging systems of FIG. 1A and FIG. 1B. The electronics 62 can operate the variable optical attenuators 276 so as to achieve the desired level of attenuation of the power of the reference signal.

Suitable devices suitable for use as an optical attenuator 276 include, but are not limited to, variable optical attenuators (VOAs), PIN diodes, and Mach-Zehnder modulators. An example of a suitable optical attenuator can be found in U.S. patent application Ser. No. 17/396,616, filed on Aug. 6, 2021, entitled “Carrier Injector Having Increased Compatibility,” and incorporated herein in its entirety.

A chirp rate identifier suitable for use as the chirp rate identifier 70 illustrated in FIG. 1A through FIG. 1C includes a signal splitter configured to split a common light signal into a first light signal and a second light signal. The chirp rate identifier also includes a signal combiner configured to combine light from the first light signal and light from the second light signal so as to form a combined signal that is beating at a beat frequency. The chirp rate identifier also includes a signal combiner configured to combine light from the first light signal and light from the second light signal so as to form a combined signal that is beating at a beat frequency. The electronics can include a beat frequency identifier that identifies the beat frequency of the combined signal and a chirp rate generator that calculates a chirp rate for the common light signal from the beat frequency of the combined signal.

FIG. 3F through FIG. 3H illustrate an example of the chirp rate identifier that is suitable for use as the chirp rate identifier 70 illustrated in FIG. 1A through FIG. 1C. FIG. 3F is a schematic of an example of a suitable optical-to-electrical assembly for use in the chirp rate identifier 70. The common waveguide 68 carries the common signal to a signal splitter 282 included in the chirp rate identifier 70. The signal splitter 282 splits the common signal into an expedited received on an expedited waveguide 284 and a delayed signal received on a delayed waveguide 286. The signal splitter 282 can be a wavelength independent splitter. For instance, the signal splitter 282 can be configured such that the delayed signal and the expedited signal carry the same or substantially the same selection of wavelengths. Suitable signal splitter 282 include, but are not limited to, directional couplers, optical couplers, Y-junctions, tapered couplers, and Multi-Mode Interference (MMI) devices.

The delay waveguide 286 carries the delayed signal to a signal combiner 288. The expedited waveguide 284 carries the expedited signal to the signal combiner 288. The delay waveguide 286 includes a delay section 289 that can be used to increase the length of the delay waveguide 286 beyond the length of the expedited waveguide 284. Although not shown in FIG. 3F, the delay section 289 can be or include a spiral arrangement of the delay waveguide 286. The longer length of the delay waveguide 286 creates a difference or delay between the time needed for the delayed signal to travel between the signal splitter 282 and the signal combiner 288, and the time needed for the expedited signal to travel between the signal splitter 282 and the signal combiner 288.

The signal combiner 288 combines the delayed signal and the expedited signal into a combined signal. Due to the delay between the delayed signal and the expedited signal, the combined signal is beating at a beat frequency. The signal combiner 288 also splits the combined signal onto a first sensor waveguide 290 and a second sensor waveguide 291. The first sensor waveguide 290 carries a first portion of the combined signal to a first light sensor 292 that converts the first portion of the second composite signal to a first sensor output signal that is an electrical signal. The second sensor waveguide 291 carries a second portion of the combined signal to a second light sensor 293 that converts the second portion of the second composite signal to a second sensor output signal that is an electrical signal. Examples of suitable light sensors include germanium photodiodes (PDs), and avalanche photodiodes (APDs).

An example of a suitable signal combiner 288 is a Multi-Mode Interference (MMI) device such as a 2×2 MMI device. Other suitable signal combiners 288 include, but are not limited to, adiabatic splitters, and directional coupler. In some instances, the functions of the illustrated signal combiner 288 are performed by more than one optical component or a combination of optical components.

The first light sensor 292 and the second light sensor 293 can be connected as a balanced detector that converts a light signal to an electrical signal. FIG. 3G provides a schematic of the relationship between electronics 62 and the optical-to-electrical assembly of FIG. 3F. The symbol for a photodiode is used to represent the first light sensor 292 and the second light sensor 293 but one or more of these sensors can have other constructions. In some instances, all of the components illustrated in the schematic of FIG. 3G are included on the LIDAR chip. In some instances, the components illustrated in the schematic of FIG. 3G are distributed between the LIDAR chip and electronics located off of the LIDAR chip.

The electronics 62 connect the first light sensor 292 and the second light sensor 293 as a balanced detector. In particular, the first light sensor 292 and the second light sensor 293 are connected in series. The serial connection in the balanced detector is in communication with a data line 294 that carries the output from the balanced detector as a data signal. The data signal is an electrical data signal that carries a representation of the combined signal. Accordingly, the data signal includes a contribution from a first waveform and a second waveform.

The electronics 62 include the data processor 237 disclosed in the context of FIG. 3A through FIG. 3E. The data processor 237 includes a beat frequency identifier 295 configured to identify the beat frequency of the combined signal. The beat frequency identifier 295 includes an Analog-to-Digital Converter (ADC) 296 that receives the data signal from the data line 294. The Analog-to-Digital Converter (ADC) 296 converts the data signal from an analog form to a digital form and outputs a digital data signal. The digital data signal is a digital representation of the data signal.

The beat frequency identifier 295 includes a mathematical transformer 297 that receives the data signal. For instance, the mathematical transformer 297 receives the digital data signal from the first Analog-to-Digital Converter (ADC) 296 as an input. The mathematical transformer 297 is configured to perform a mathematical transform on the digital data signal so as to convert from the time domain to the frequency domain. The mathematical transform can be a real transform such as a real Fast Fourier Transform (FFT).

The mathematical transformer 297 can include a peak finder (not shown) configured to identify peaks in the output of the mathematical transformer 297. The peak finder can be configured to identify the frequency peak associated with the chirp rate identifier. For instance, the frequency peaks associated with the chirp rate identifier can fall within a frequency range. The peak finder can identify the frequency peak with the range of frequencies associated with the chirp rate identifier. The frequency of the identified frequency peak represents the beat frequency of the combined signal.

The data processor 237 includes a chirp rate generator 299 that receives the beat frequency of the combined signal from the peak finder. Additionally, the chirp rate generator 299 is configured to calculate the chirp rate (αₙ) from the beat frequency of the combined signal. For instance, the chirp rate generator 299 can calculate a magnitude of the chirp rate (αₙ) from mαₙ=fₚ/τₚ where mαₙ represents the magnitude of the chirp rate (αₙ), fₚ represents the beat frequency of the combined signal that results from the data period with period index n and τₚ represents the difference or delay between the time needed for the delayed signal to travel between the signal splitter 282 and the signal combiner 288 and the time needed for the expedited signal to travel between the signal splitter 282 and the signal combiner 288. The value of τₚ can be stored by the chirp rate generator 299 for calculating the chirp rate (αₙ). The chirp rate generator 299 can assign the direction of the target chirp rate (tαₙ) for the data period with period index n to the magnitude of the chirp rate (mαₙ) to provide a chirp rate (αₙ) with both magnitude and direction.

The chirp rate generator 299 can generate a value for the chirp rate (αₙ) for a data period with period index n. Accordingly, all or a portion of the data periods can be associated with different chirp rates (αₙ) where the different chirp rates (αₙ) are each generate by the chirp rate generator 299.

The electronics 62 and data processor 237 illustrated in FIG. 3G include the components illustrated in the data processor 237 of FIG. 3B, FIG. 3D, or FIG. 3E, however, to simplify the image, only a portion of the components are illustrated. For instance, FIG. 3G illustrates the electronics 62 and data processor 237 includes a LIDAR data generator 270 and beat frequency identifier 238 disclosed in the context of FIG. 3A through FIG. 3E. Accordingly, the LIDAR data generator 270 receives from the beat frequency identifier 238 of FIG. 3B, FIG. 3D, or FIG. 3E the beat frequencies of any frequency peaks associated with the one or more objects located outside of the LIDAR system. For instance, the LIDAR data generator 270 can receive from a peak finder included in a beat frequency identifier 238 the beat frequencies of any frequency peaks associated with the one or more objects located outside of the LIDAR system. Additionally, the LIDAR data generator 270 receives the different chirp rates (αₙ) from the chirp rate generator 299. The LIDAR data generator 270 combines the chirp rates (αₙ) associated with a sample region with the beat frequencies that result from illuminating that same sample region so as to calculate the LIDAR data for the sample region as disclosed in the context of FIG. 3C. The LIDAR data generator 270 receives chirp rates (αₙ) associated with a sample region and beat frequencies that result from illuminating that sample region for a series of sample regions. As a result, the LIDAR data generator 270 calculates the LIDAR data for the series of sample regions.

In the example chirp rate identifier of FIG. 3F through FIG. 3H, the common signal carried by the common waveguide 68 serves as the common light signal and the common waveguide 68 serves as a common waveguide. Additionally, the delayed signal serves as the second light signal with the delayed waveguide serving as a first waveguide. The expedited signal serves as the first light signal with the expedited waveguide serving as the first waveguide.

The chirp branch illustrated in FIG. 1A through FIG. 1C can be optional. For instance, the components of the cores of FIG. 1A through FIG. 1C can serve as the components of the chirp rate identifier disclosed in the context of FIG. 3F through FIG. 3H. For instance, one or more optical components in the LIDAR system that are located after one of the splitters 24 can serve as a chirp rate detection component. A suitable chirp rate detection component can receive a light signal that includes light from the outgoing LIDAR signal and cause a portion of the light signal to be reflected as a reflection signal that travels along an optical pathway that includes one of the splitters 24. In a LIDAR core constructed according to FIG. 1A, examples of chirp rate detection components include, but are not limited to, the signal director 14, ports 18, waveguide facets, and components external to the chip such as fiber optics, optical connectors, lenses, collimators, polarizers, polarization rotators, Faraday rotators, beam scanning mirrors and/or other beam scanning devices. In the LIDAR constructed according to FIG. 1A, the utility waveguide 12 can carry the reflection signal to the splitter 24. In a LIDAR core constructed according to FIG. 1B or FIG. 1C, examples of chirp rate detection components include, but are not limited to, ports 18, waveguide facets, ports 18, and components external to the chip such as fiber optics, optical connectors, lenses, collimators, polarizers, polarization rotators, Faraday rotators, beam scanning mirrors, and/or other beam scanning devices. In the LIDAR constructed according to FIG. 1B or FIG. 1C, an alternate waveguide can carry the reflection signal to one of the splitters 24.

In some instances, a chirp rate detection component can be added to a LIDAR system constructed according to FIG. 1A through FIG. 1C. For instance, a perturbation region can be added to the utility waveguide 12 of FIG. 1A so as to cause a portion of the outgoing LIDAR signal traveling along the utility waveguides to be reflected back toward the splitter 24. Alternately, a perturbation region can be added to each of the alternate waveguides 16 of FIG. 1B through FIG. 1C so as to cause a portion of the outgoing LIDAR signal traveling along each of the alternate waveguides 16 to be reflected back toward one of the splitters 24. Examples of suitable perturbation regions include, but are not limited to, a recess that extends into the waveguide, Bragg gratings, offset waveguides, waveguide tapers and waveguide bends.

In the cores of FIG. 1A through FIG. 1C, a splitter 24 can move a portion of a reflection signal from the utility waveguide 12 onto the comparative waveguide 26 or from one of the alternate waveguides 16 onto one of the comparative waveguides 26. As discussed above, the splitter 24 also moves a portion of the incoming LIDAR signal from the utility waveguide 12 onto a comparative waveguide 26 as a comparative signal. The portion of the reflection signal on a comparative waveguide 26 can serve as a chirp detection signal. The chirp detection signal joins the comparative signal on the comparative waveguide 26. The comparative waveguide 26 carries the chirp detection signal and the comparative signal to the signal processor 28 for further processing.

The signal processor 28 combines the comparative signal, chirp detection signal, and reference signal to form the composite signal that carries LIDAR data for a sample region on the field of view. For instance, as noted above, the signal processor 28 includes one or more light signal combiners that combine the comparative signal, chirp detection signal, and reference signal to form the composite signal. Accordingly, the composite signal can be processed so as to extract LIDAR data (radial velocity and/or distance between a LIDAR system and an object external to the LIDAR system) for the sample region.

The signal processor 28 disclosed in the context of FIG. 3A through FIG. 3E can be modified to include the chirp rate generator 299 disclosed in the context of FIG. 3G. For instance, FIG. 3H illustrates the schematic of FIG. 3B modified to include the chirp rate generator 299 of FIG. 3G. The chirp rate generator 299 receives the output from the mathematical transformer 268. As noted above, the composite signal includes a contribution from the

The output from the mathematical transformer 268 will include a frequency peak from the chirp rate detection component. For instance, the output from the mathematical transformer 268 will include a frequency peak resulting from the chirp detection signal beating against the reference signal. Additionally, when one or more objects located outside of the LIDAR system reflect the system output signal, the output from the mathematical transformer 268 will include a frequency peak from the one or more objects. As a result, the output from the mathematical transformer 268 can also include one or more frequency peaks resulting from the comparative signal beating against the reference signal. The frequency peak from the chirp rate detection component will occur at lower frequencies than the frequency peaks from the one or more object due to the one or more objects having a longer delay between the reference signal and the comparative signal than is present between the reference signal and the chirp detection signal.

The chirp rate generator 299 can include a peak finder (not shown) configured to identify the frequency peaks in the output of the mathematical transformer 297. The peak finder can be configured to identify the frequency peak associated with the chirp rate detection component and also any frequency peaks associated with the one or more object. For instance, the frequency peaks associated with the chirp rate detection component can fall within a different frequency range than the frequency peaks associated with the one or more objects. Accordingly, the peak finder can associate a frequency peak within the range associated with the chirp rate detection component as being the frequency peak resulting from the chirp rate detection component. Additionally, the peak finder can associate any frequency peaks within the range associated with the one or more objects as being the frequency peaks that result from the one or more objects.

The chirp rate generator 299 receives from the peak finder the frequency of the frequency peak resulting from the chirp rate detection component. Additionally, the chirp rate generator 299 is configured to calculate the chirp rate (αₙ) from the frequency peak resulting from the chirp rate detection component. For instance, the chirp rate generator 299 can calculate a magnitude of the chirp rate (αₙ) from mαₙ=fₚ/τₚ where mαₙ represents the magnitude of the chirp rate (αₙ), fₚ represents the frequency of the frequency peak resulting from the chirp rate detection component during the data period with period index n and τₚ represents the delay between the time needed for the reference signal to reach the light signal combiners (light signal combiner 211 and second light signal combiner 212) from the splitter 24 and the time needed for the chirp detection signal to reach the light signal combiners (light signal combiner 211 and second light signal combiner 212) from the splitter 24. The value of τₚ for a particular chirp rate detection component can be known and can be stored by the chirp rate generator 299 for calculating the chirp rate. The chirp rate generator 299 can assign the direction of the corresponding target chirp rate (tαₙ) to the magnitude of the chirp rate (mαₙ) to provide a chirp rate (αₙ) with both magnitude and direction.

In some instances, the value of τₚ may not be known or is not known. In these instances, the chirp rate generator 299 can estimate the value of τₚ from τₚₑₛₜ=|fₚᵣᵢₙₜ/ταₙ| where τₚₑₛₜ represents an estimated value of τₚ, tan represents the target chirp rate for the data periods associated with period index n and fₚᵢₙᵢₜ represents the frequency of the frequency peak resulting from the chirp rate detection component during a data period that is associated with period index n and that occurs near initiation, or startup, of the operation of the LIDAR system. When the operation of the LIDAR system is initiated, there is a reduced level of error between the actual chirp rates (αₙ) and the target chirp rates (tαₙ). As a result, the combination of the tαₙ and fₚᵢₙᵢₜ can provide an accurate estimate for the value of τₚ. In some instances, the value of fₚᵢₙᵢₜ represents the frequency at the frequency peak resulting from the chirp rate detection component during a data period that is associated with period index n and that occurs within the first 1, 10, or 100 cycles after initiating, or starting, operation of the LIDAR system so as to generate the LIDAR data. Because the value of τₚ can be estimated, the actual identity of the chirp rate detection component need not be known.

The chirp rate generator 299 can estimate a single value for τₚₑₛₜ using one of the data periods and can set τₚ to the value of τₚₑₛₜ (tip=τₚₑₛₜ). Alternately, the chirp rate generator 299 can estimate different value(s) of τₚₑₛₜ for different data periods. As a result, the final value of τₚ can be a function of multiple different τₚ values. As an example, the chirp rate generator 299 can average multiple different τₚₑₛₜ values to generate a value for τₚ. When the chirp rate generator 299 estimates a value for τₚ, the chirp rate generator 299 can calculate the chirp rates (αₙ) from αn=fₚ/τₚ as disclosed above.

The LIDAR data generator 270 receives from the beat frequency identifier 238 the chirp rates (αₙ) and the frequencies of any frequency peaks associated with the one or more objects located outside of the LIDAR system. For instance, the LIDAR data generator 270 receives from the chirp rate generator 299 the chirp rates (αₙ) and the frequencies of any frequency peaks associated with the one or more objects located outside of the LIDAR system. As a result, the LIDAR data generator 270 combines the chirp rates (αₙ) associated with a sample region with any beat frequencies that result from illuminating that same sample region so as to calculate the LIDAR data for the sample region as disclosed in the context of FIG. 3C. The LIDAR data generator 270 receives chirp rates (αₙ) associated with a sample region and beat frequencies that result from illuminating that sample region for a series of sample regions. As a result, the LIDAR data generator 270 calculates the LIDAR data for the series of sample regions.

FIG. 3H illustrates the schematic of FIG. 3B modified to include the chirp rate generator 299; however, the schematic of FIG. 3D and FIG. 3E can be modified to include the chirp rate generator 299 as shown in FIG. 3I and FIG. 3J. The chirp rate generator 299 and the LIDAR data generator 270 of FIG. 3I and FIG. 3J are constructed and operated as disclosed in the context of FIG. 3H.

When cores constructed according to FIG. 1A through FIG. 1C have a signal processor constructed as disclosed in the context of FIG. 3H through FIG. 3J, the components of the cores serve as a chirp rate identifier. As noted above, a chirp rate identifier includes a signal splitter configured to split a common light signal into a first light signal and a second light signal. The splitter 24 serves as the signal splitter for the chirp rate identifier with the outgoing LIDAR signal serving as a common light signal. Additionally, the reference signal serves as the first light signal and the reference waveguide serving as a first waveguide. The portion of the outgoing LIDAR signal output from the splitter 24 combined with the resulting reflection signal and resulting chirp detection signal serve as the second light signal. For instance, the portion of the outgoing LIDAR signal that is present in the chirp detection signal and also in the reflection signal serves as the second light signal. The chirp rate identifier also includes a signal combiner configured to combine light from the first light signal and light from the second light signal so as to form a combined signal that is beating at a beat frequency. The light signal combiner 211 and/or the second light signal combiner 212 serve as the signal combiner for the chirp rate identifier. For instance, the light signal combiner 211 and/or the second light signal combiner 212 combine the comparative signal, chirp detection signal, and reference signal to form the composite signal. The chirp detection signal and reference signal are beating within the composite signal and accordingly serve as the combined signal for the chirp rate identifier. The beat frequency identifier 238 identifies the beat frequency of the combined signal and the chirp rate generator 270 calculates the chirp rate for the common light signal.

The electronics 62 illustrated in FIG. 3A through FIG. 3J include only a portion of the components in the electronics. For instance, the electronics 62 illustrated in FIG. 62 can also include a director controller 15 and a light source controller 63 in communication with the data processor 237.

Although the mathematical transformers 268 are disclosed as performing complex transforms on a complex signal, the complex transforms can be replaced with real transforms performed on real signals. As a result, the optical-to-electrical assembly of FIG. 3A can be simplified so as to exclude the second light-combining component 212, the comparative waveguide 206, the second splitter 202, the second reference waveguide 208, first auxiliary light sensor 218, the second auxiliary light sensor 220, and the associated components shown in FIG. 3B, FIG. 3D and FIG. 3E.

Suitable platforms for the LIDAR chip include, but are not limited to, silica, indium phosphide, and silicon-on-insulator wafers. FIG. 4 is a cross section of a silicon-on-insulator wafer. A silicon-on-insulator (SOI) wafer includes a buried layer 300 between a substrate 302 and a light-transmitting medium 304. In a silicon-on-insulator wafer, the buried layer 300 is silica while the substrate 302 and the light-transmitting medium 304 are silicon. The substrate of an optical platform such as an SOI wafer can serve as the base for a LIDAR chip. For instance, in some instances, the optical components shown in FIG. 1A through FIG. 1C can be positioned on or over the top and/or lateral sides of the same substrate. As a result, the substrate of an optical platform such as an SOI wafer can serve as a base 305.

The portion of the LIDAR chip illustrated in FIG. 4 includes a waveguide construction that is suitable for use with chips constructed from silicon-on-insulator wafers. A ridge 306 of the light-transmitting medium 304 extends away from slab regions 308 of the light-transmitting medium 304. The light signals are constrained between the top of the ridge and the buried layer 300. As a result, the ridge 306 at least partially defines the waveguide.

The dimensions of the ridge waveguide are labeled in FIG. 4. For instance, the ridge has a width labeled w and a height labeled h. A thickness of the slab regions is labeled t. For LIDAR applications, these dimensions can be more important than other applications because of the need to use higher levels of optical power than are used in other applications. The ridge width (labeled w) is greater than 1 μm and less than 4 μm, the ridge height (labeled h) is greater than 1 μm and less than 4 μm, the slab region thickness is greater than 0.5 μm and less than 3 μm. These dimensions can apply to straight or substantially straight portions of the waveguide, curved portions of the waveguide and tapered portions of the waveguide(s). Accordingly, these portions of the waveguide will be single mode. However, in some instances, these dimensions apply to straight or substantially straight portions of a waveguide. Additionally or alternately, curved portions of a waveguide can have a reduced slab thickness in order to reduce optical loss in the curved portions of the waveguide. For instance, a curved portion of a waveguide can have a ridge that extends away from a slab region with a thickness greater than or equal to 0.0 μm and less than 0.5 μm. While the above dimensions will generally provide the straight or substantially straight portions of a waveguide with a single-mode construction, they can result in the tapered section(s) and/or curved section(s) that are multimode. Coupling between the multi-mode geometry to the single mode geometry can be done using tapers that do not substantially excite the higher order modes. Accordingly, the waveguides can be constructed such that the signals carried in the waveguides are carried in a single mode even when carried in waveguide sections having multi-mode dimensions. The waveguide construction of FIG. 4 is suitable for all or a portion of the waveguides on a LIDAR chip constructed according to FIG. 1A through FIG. 1C.

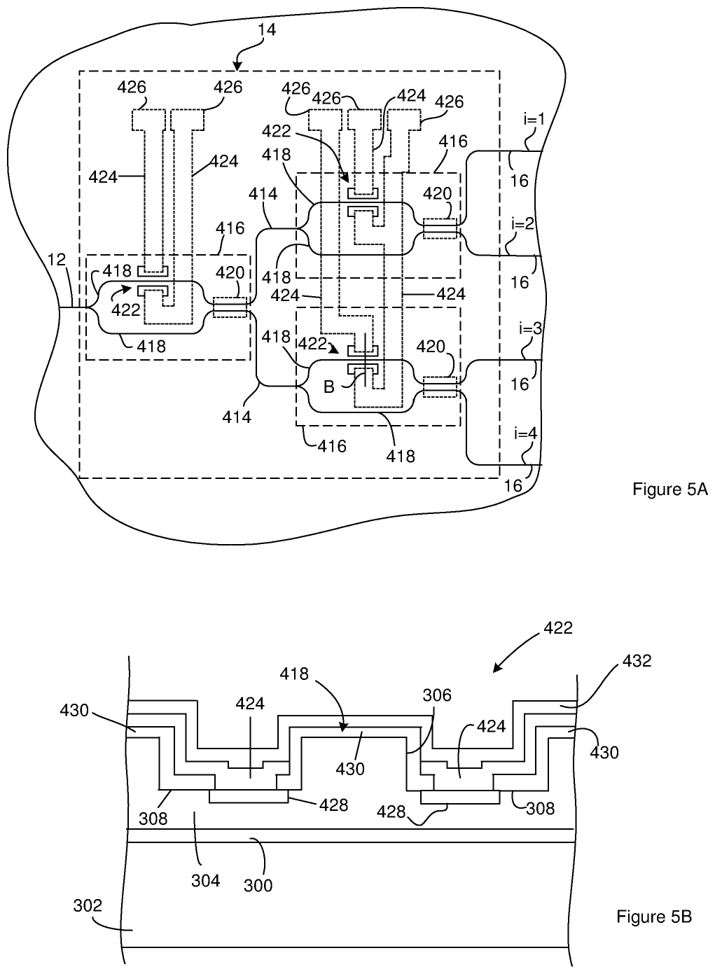

Suitable signal directors 14 for use with the LIDAR chip include, but are not limited to, optical switches such as cascaded Mach-Zehnder interferometers and micro-ring resonator switches. In one example, the signal director 14 includes cascaded Mach-Zehnder interferometers that use thermal or free-carrier injection phase shifters. FIG. 5A and FIG. 5B illustrate an example of an optical switch that includes cascaded Mach-Zehnder interferometers 416. FIG. 5A is a topview of the optical switch. FIG. 5B is a cross section of the optical switch shown in FIG. 5A taken along the line labeled B in FIG. 5A.

The optical switch receives the outgoing LIDAR signal from the utility waveguide 12. The optical switch is configured to direct the outgoing LIDAR signal to one of several alternate waveguides 16. The optical switch includes interconnect waveguides 414 that connect multiple Mach-Zehnder interferometers 416 in a cascading arrangement. Each of the Mach-Zehnder interferometers 416 directs the outgoing LIDAR signal to one of two interconnect waveguides 414. The director controller 15 can operate each Mach-Zehnder so as to select which of the two interconnect waveguides 414 receives the outgoing LIDAR signal from the Mach-Zehnder interferometer 416. The interconnect waveguides 414 that receive the outgoing LIDAR signal can be selected such that the outgoing LIDAR signal is guided through the optical switch to a particular one of the alternate waveguides 16.

Each of the Mach-Zehnder interferometers 416 includes two branch waveguides 418 that each receives a portion of the outgoing LIDAR signal from the utility waveguide 12 or from an interconnect waveguide 414. Each of the Mach-Zehnder interferometers 416 includes a direction component 420 that receives two portions of the outgoing LIDAR signal from the branch waveguides 418. The direction component 420 steers the outgoing LIDAR signal to one of the two interconnect waveguides 414 configured to receive the outgoing LIDAR signal from the direction component 420. The interconnect waveguide 414 to which the outgoing LIDAR signal is directed is a function of the phase differential between the two different portions of the outgoing LIDAR signal received by the direction component 420. Although FIG. 5A illustrates a directional coupler operating as the direction component 420, other direction components 420 can be used. Suitable alternate direction components 420 include, but are not limited to, Multi-Mode Interference (MMI) devices and tapered couplers.

Each of the Mach-Zehnder interferometers 416 includes a phase shifter 422 positioned along one of the branch waveguides 418. The output component includes conductors 424 in electrical communication with the phase shifters 422. The conductors 424 are illustrated as dashed lines so they can be easily distinguished from underlying features. The conductors 424 each terminate at a contact pad 426. The contact pads 426 can be used to provide electrical communication between the conductors 424 and the electronics. Accordingly, the conductors 424 provide electrical communication between the electronics and the phase shifters 422 and allow the electronics to operate the phase shifters 422. Suitable conductors 424 include, but are not limited to, metal traces. Suitable materials for the conductors include, but are not limited to, titanium, aluminum and gold.

The electronics can operate each of the phase shifters 422 so as to control the phase differential between the portions of the outgoing LIDAR signal received by a direction component 420. In one example, a phase shifter 422 can be operated so as to change the index of refraction of a portion of at least a portion of a branch waveguide 418. Changing the index of a portion of a branch waveguide 418 in a Mach-Zehnder interferometer 416, changes the effective length of that branch waveguides 418 and accordingly changes the phase differential between the portions of the outgoing LIDAR signal received by a direction component 420. The ability of the electronics to change the phase differential allows the electronics to select the interconnect waveguide 414 that receives the outgoing LIDAR signal from the direction component 420.

FIG. 5B illustrates one example of a suitable construction of a phase shifter 422 on a branch waveguide 418. The branch waveguide 418 is at least partially defined by a ridge 306 of the light-transmitting medium 304 that extends away from slab regions 308 of the light-transmitting medium 304. Doped regions 428 extend into the slab regions 308 with one of the doped regions including an n-type dopant and one of the doped regions 428 including a p-type dopant. A first cladding 430 is positioned between the light-transmitting medium 304 and a conductor 424. The conductors 424 each extend through an opening in the first cladding 430 into contact with one of the doped regions 428. A second cladding 432 is optionally positioned over the first cladding 430 and over the conductor 424. The electronics can apply a forward bias can be applied to the conductors 424 so as to generate an electrical current through the branch waveguide 418. The resulting injection of carriers into the branch waveguide 418 causes free carrier absorption that changes the index of refraction in the branch waveguide 418.

The first cladding 430 and/or the second cladding 432 illustrated in FIG. 5B can each represent one or more layers of materials. The materials for the first cladding 430 and/or the second cladding 432 can be selected to provide electrical isolation of the conductors 424, lower index of refraction relative to the light-transmitting medium 304, stress reduction and mechanical and environmental protection. Suitable materials for the first cladding 430 and/or the second cladding 432 include, but are not limited to, silicon nitride, tetraorthosilicate (TEOS), silicon dioxide, silicon nitride, and aluminum oxide. The one or more materials for the first cladding 430 and/or the second cladding 432 can be doped or undoped.

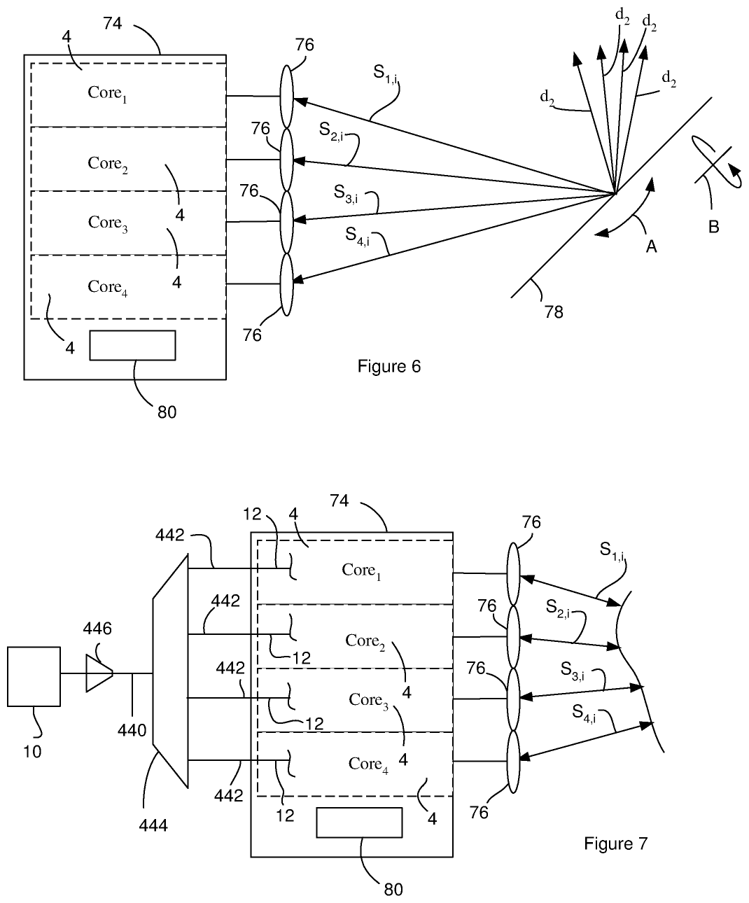

In instances where the LIDAR system includes multiple cores, the LIDAR system can include multiple signal directors 76 and different signal directors 76 can receive LIDAR output signals from different selections of the signal directors 76. As an example, FIG. 6 illustrates the LIDAR system of FIG. 2 modified to have multiple signal directors 76 that each receives LIDAR output signals from a different one of the cores.

FIG. 1A through FIG. 1C illustrate each of the cores including a different light source 10. However, the multiple cores, all of the cores, or a portion of the cores can receive the outgoing LIDAR signal from a common light source. In some instances, the cores are arranged in groups where each core in a group receives the outgoing LIDAR signal from the same common light source and the cores in different groups receives the outgoing LIDAR signal from the different common light sources. In some instances, a group of cores can include a single one of the cores. As an example, FIG. 7 illustrates the LIDAR system of FIG. 2 where a light source 10 is located external to the cores and each of the cores receives an outgoing LIDAR signal from the light source.

A first optical link 440 provide optical communication between the light source 10 and a signal splitter 442. Second optical links 444 provide optical communication between the signal splitter 442 and the utility waveguides 12 on different cores 4. The light source 10 outputs a preliminary signal that is received on the first optical link 440. The signal splitter 442 receives the preliminary signal from the first optical link 440. The signal splitter 442 splits the preliminary signal into a split signals that are each received on a different one of the second optical links 444. Each of the utility waveguides 12 receive a split signal from a different one of the optical links 444. The portion of a split signal that enters a utility waveguide serves as the outgoing LIDAR signal.

The LIDAR system can optionally include an amplifier 446 positioned along the first optical link 440 so as to amplify the power of the preliminary signal. Suitable amplifiers 446 for use along an optical link, include, but are not limited to, SOAs, Erbium Doped Fiber Amplifiers (EDFAs), and Preasodymium Doped Fiber Amplifiers (PDFAs).

When it is desirable for the different outgoing LIDAR signals to have the same or substantially the same distribution of wavelengths, suitable signal splitters 442 include, but are not limited to, wavelength independent signal combiners such as an optical couplers, y-junctions, MMIs, cascaded evanescent optical couplers, and cascaded y-junctions. When it is desirable for the different outgoing LIDAR signals to have different wavelength distributions, suitable signal splitters 442 include, but are not limited to, wavelength dependent signal splitters 442 including optical demultiplexers such as Arrayed Waveguide Gratings (AWGs), and echelle gratings.

In some instances where multiple different cores receive an outgoing LIDAR signal from a common light source, only one of the cores that receives its outgoing LIDAR signal from the common light source includes a control branch. As a result, the other cores that receives an outgoing LIDAR signal from the same common light source can exclude the directional coupler 66, common waveguide 68, and control branch illustrated in FIG. 1A through FIG. 1C.

As is evident from FIG. 1A and FIG. 1B, the LIDAR system can optionally include one or more light signal amplifiers 446. For instance, an amplifier 446 can optionally be positioned along a utility waveguide as illustrated in the LIDAR system of FIG. 1A. In another example, an amplifier 446 is optionally positioned along all or a portion of the alternate waveguides 16 as illustrated in the LIDAR system of FIG. 1B. The electronics can operate the amplifier 446 so as to amplify the power of the outgoing LIDAR signal and accordingly of the system output signal. The electronics can operate each of the amplifiers 446 so as to amplify the power of the outgoing LIDAR signal. Suitable amplifiers 446 for use on the LIDAR chip, include, but are not limited to, Semiconductor Optical Amplifiers (SOAs).

The amplifiers 446 shown in FIG. 1A and FIG. 1B are each positioned before one of the splitters 24. In some instances, this location of the amplifiers 446 can cause saturation of one or more components selected from a group consisting of the first auxiliary light sensor 218, the second auxiliary light sensor 220, the first light sensor 223, and the second light sensor 224. For instance, the amplifier 446 can increase power level of the reference signal to a level where saturation occurs. A beam dump can be used to reduce the power level of the reference signal to a level where saturation is reduced or eliminated.

As is evident from FIG. 3B, FIG. 3D, and FIG. 3E, the LIDAR system can optionally include one or more electrical signal amplifiers 447. Each of the amplifiers 447 is positioned so as to provide amplification of a first data signal traveling between a first light sensor such as a first balanced detector 225 and an analog to digital converter or a second data signal traveling between a second light sensor such as a second balanced detector 226 and an analog to digital converter. Although FIG. 3D illustrates each of the electrical signal amplifiers 447 positioned along a first data line 228 or a second data line 232, the electrical signal amplifiers 447 can be positioned along a common data line 273 or a second common data line 275. Although FIG. 3E illustrates each of the electrical signal amplifiers 447 positioned along a common data line 273 or a second common data line 275, the electrical signal amplifiers 447 can be positioned along a first data line 228 or a second data line 232. Suitable electrical signal amplifiers 447 include, but are not limited to, Transimpedance Amplifiers (TIAs).

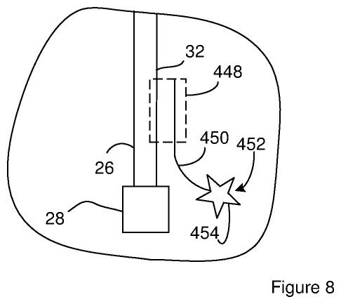

FIG. 8 illustrates a portion of a LIDAR chip that includes a reference waveguide 32 used in conjunction with a beam dump configured to reduce the power level of the reference signal carried on the reference waveguide 32. The reference waveguide 32 carries the reference signal to a splitter 448 that moves a portion of the reference signal from the reference waveguide 32 onto a dump waveguide 450 as a dump signal. The dump waveguide 450 carries the dump signal to a beam dump 452.

The beam dump 452 is configured to scatter the dump signal without reflecting a substantial amount of the light from the dump signal back into the dump waveguide 450. For instance, the beam dump 452 can be a recess 454 etched into the light-transmitting medium of a silicon-on-insulator wafer to a depth where the dump signal is incident on one or more lateral sides of the recess 454. The recess 454 can be shaped so as to cause scattering of the dump signal. For instance, the recess 454 can have the shape of a star, or can include any number of irregularly positioned lateral sides. In some instances, the recess 454 can extends through the light transmitting to medium to an underlying layer such as the buried layer of a silicon-on-insulator wafer.

The splitter 448 can be constructed so as to control the percentage of the reference signal power transferred to the dump waveguide. Increasing the percentage of the reference signal power transferred to the dump waveguide increases attenuation of the power of reference signal and accordingly decreases the power of the signals received by all or a portion of the light sensors selected from a group consisting of the first auxiliary light sensor, the second auxiliary light sensor, the first light sensor, and the second light sensor. The drop in power of the light signals received by all or a portion of the light sensors reduces the opportunity for saturation. Suitable splitters 448 include, but are not limited to, 1×2 splitters including optical couplers, y-junctions, and MMIs. In some instances, the splitters 448 is configured such that percentage of the reference signal power transferred to the dump waveguide 450 is greater than or equal to 0.1%, 0.5%, or 1% and less than or equal to 2%, 10%, or 20%.

Light sensors that are interfaced with waveguides on a LIDAR chip can be a component that is separate from the chip and then attached to the chip. For instance, the light sensor can be a photodiode, or an avalanche photodiode. Examples of suitable light sensor components include, but are not limited to, InGaAs PIN photodiodes manufactured by Hamamatsu located in Hamamatsu City, Japan, or an InGaAs APD (Avalanche Photo Diode) manufactured by Hamamatsu located in Hamamatsu City, Japan. These light sensors can be centrally located on the LIDAR chip. Alternately, all or a portion the waveguides that terminate at a light sensor can terminate at a facet located at an edge of the chip and the light sensor can be attached to the edge of the chip over the facet such that the light sensor receives light that passes through the facet. The use of light sensors that are a separate component from the chip is suitable for all or a portion of the light sensors selected from the group consisting of the first light sensor and the second light sensor.

As an alternative to a light sensor that is a separate component, all or a portion of the light sensors can be integrated with the chip. For instance, examples of light sensors that are interfaced with ridge waveguides on a chip constructed from a silicon-on-insulator wafer can be found in Optics Express Vol. 15, No. 21, 13965-13971 (2007); U.S. Pat. No. 8,093,080, issued on Jan. 102012; U.S. Pat. No. 8,242,432, issued Aug. 142012; and U.S. Pat. No. 6,108,8472, issued on Aug. 22, 2000 each of which is incorporated herein in its entirety. The use of light sensors that are integrated with the chip are suitable for all or a portion of the light sensors selected from the group consisting of the first light sensor and the second light sensor.

As noted above, the electronics that operate the system include electronics 62 and an assembly controller 280. The electronics 62 are each associated with one of the cores (i.e. local electronics). In contrast, the assembly controller 280 can be associated with multiple cores (i.e. common electronics). While electronics 62 and an assembly controller 280 are shown as being in different locations, the electronics 62 and an assembly controller 280 can be in a common location and/or common packaging. Further, the electronics 62 for each of the cores and the assembly controller 280 can be integrated and need not refer to discrete or distinct electronic components. For instance, the electronics 62 associated with different cores can optionally be consolidated with the assembly controller 280. The consolidated assembly controller 280 can be positioned on a LIDAR chip or on a support 77. The assembly controller 280 or consolidated assembly controller 280 can collect or generate the LIDAR data results from different cores, and/or can coordinate the LIDAR data results from different cores so as to assemble LIDAR data results for the LIDAR system's field of view.

Suitable electronics 62 for use in the LIDAR system can include, but are not limited to, a controller that includes or consists of analog electrical circuits, digital electrical circuits, processors, microprocessors, digital signal processors (DSPs), Application Specific Integrated Circuits (ASICs), computers, microcomputers, or combinations suitable for performing the operation, monitoring and control functions described above. In some instances, the controller has access to a memory that includes instructions to be executed by the controller during performance of the operation, control and monitoring functions. Although the electronics are illustrated as a single component in a single location, the electronics can include multiple different components that are independent of one another and/or placed in different locations. Additionally, as noted above, all or a portion of the disclosed electronics can be included on the chip including electronics that are integrated with the chip.

An example of a suitable director controller 15 executes the attributed functions using firmware, hardware, or software or a combination thereof. An example of a suitable light source controller 63 executes the attributed functions using firmware, hardware, or software or a combination thereof. An example of a suitable data processor 237 executes the attributed functions using firmware, hardware, or software or a combination thereof. An example of a suitable assembly controller 280 executes the attributed functions using firmware, hardware, or software or a combination thereof.

Components on the LIDAR chip can be fully or partially integrated with the LIDAR chip. For instance, the integrated optical components can include or consist of a portion of the wafer from which the LIDAR chip is fabricated. A wafer that can serve as a platform for a LIDAR chip can include multiple layers of material. At least a portion of the different layers can be different materials. As an example, a silicon-on-insulator wafer that includes the buried layer 300 between the substrate 302 and the light-transmitting medium 304 as shown in FIG. 4. The integrated on-chip components can be formed by using etching and masking techniques to define the features of the component in the light-transmitting medium 304. For instance, the slab 318 that define the waveguides and the stop recess can be formed in the desired regions of the wafer using different etches of the wafer. As a result, the LIDAR chip includes a portion of the wafer and the integrated on-chip components can each include or consist of a portion of the wafer. Further, the integrated on-chip components can be configured such that light signals traveling through the component travel through one or more of the layers that were originally included in the wafer. For instance, the waveguide of FIG. 4 guides light signal through the light-transmitting medium 304 from the wafer. The integrated components can optionally include materials in addition to the materials that were present on the wafer. For instance, the integrated components can include reflective materials and/or a cladding.

Numeric labels such as first, second, third, etc. are used to distinguish different features and components and do not indicate sequence or existence of lower numbered features. For instance, a second component can exist without the presence of a first component and/or a third step can be performed before a first step. The light signals disclosed above each include, consist of, or consist essentially of light from the prior light signal(s) from which the light signal is derived. For instance, an incoming LIDAR signal includes, consists of, or consists essentially of light from the LIDAR input signal.

Although the LIDAR system is disclosed as using complex signals such as the complex data signal, the LIDAR system can also use real signals. As a result, the mathematical transform can be a real transform and the components associated with the generation and use of the quadrature components can be removed from the LIDAR system. As a result, the LIDAR system can use a single signal combiner. Additionally or alternately, a single light sensor can replace each of the balanced detectors.

Although the imaging system and LIDAR system are disclosed as having steerable system output signals, the imaging system and LIDAR system can be used in applications where the system output signal(s) are not steered. As a result, the optical component assembly 75 is optional.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. A LIDAR system, comprising:
a signal splitter configured to split a common light signal into a first light signal and a second light signal;
a signal combiner configured to combine light from the first light signal and light from the second light signal so as to form a combined signal that is beating at a beat frequency; and
electronics that include a beat frequency identifier configured to identify the beat frequency of the combined signal,
the electronics including a chirp rate generator configured to calculate a chirp rate for the common light signal from the beat frequency of the combined signal.

2. The system of claim 1, wherein the chirp rate generator being configured to calculate the chirp rate includes the chirp rate generator being configured to calculate a magnitude of the chirp rate according to mαₙ=fₚ/τₚ where mαₙ represents the magnitude of the chirp rate, fₚ represents the beat frequency of the combined signal, and τₚ represents a delay between a time needed for the first light signal to travel between the signal splitter and the signal combiner and a time needed for the second light signal to travel between the signal splitter and the signal combiner.

3. The system of claim 1, wherein the electronics include a LIDAR data generator configured to calculate LIDAR data from the chirp rate calculated by the chirp rate generator, the LIDAR data indicating a radial velocity and/or distance between the imaging system and an object external to the imaging system.

4. The system of claim 1, wherein the signal combiner is also configured to combine the light from the first light signal with light from a comparative signal so as to form a composite signal that is beating at a composite signal beat frequency,
the light from the comparative signal including light from the common signal that has exited from the imaging system, that has been reflected by an object located outside of the imaging system, and that has returned to the imaging system.

5. The system of claim 4, wherein the beat frequency identifier is configured to identify the composite signal beat frequency.

6. The system of claim 5, wherein the electronics include a LIDAR data generator configured to calculate LIDAR data from the chirp rate calculated by the chirp rate generator and also from the composite signal beat frequency identified by the beat frequency identifier, the LIDAR data indicating a radial velocity and/or distance between the imaging system and an object external to the imaging system.

7. The system of claim 1, further comprising: a chirp rate detection component that reflects the second light signal but transmits the light that is from the common signal and that is included in the comparative signal.

8. The system of claim 1, wherein the signal splitter and signal combiner are included in a photonic circuit on a semiconductor chip.

9. The system of claim 1, wherein a second signal splitter taps the common signal from an outgoing LIDAR signal.

10. The system of claim 1, wherein the chirp rate generator is configured to calculate an approximate duration of a delay between a time needed for the first light signal to travel between the signal splitter and the signal combiner and a time needed for the second light signal to travel between the signal splitter and the signal combiner.

11. A method of operating a LIDAR system, comprising:
splitting a common light signal into a first light signal and a second light signal;
combining light from the first light signal and light from the second light signal so as to form a combined signal that is beating at a beat frequency;
identifying the beat frequency of the combined signal; and
calculating a chirp rate for the common light signal from the beat frequency of the combined signal.

12. The method of claim 11, further comprising:
calculating LIDAR data from the calculated chirp rate, the LIDAR data indicating a radial velocity and/or distance between the imaging system and an object external to the imaging system.

13. The method of claim 11, wherein calculating the chirp rate includes calculating a magnitude of the chirp rate according to mαₙ=fₚ/τₚ where mαₙ represents the magnitude of the chirp rate, fₚ represents the beat frequency of the combined signal, and τₚ represents a delay between a time needed for the first light signal to travel between the signal splitter and the signal combiner and a time needed for the second light signal to travel between the signal splitter and the signal combiner.

14. The method of claim 11, further comprising:
calculating LIDAR data from the calculated chirp rate, the LIDAR data indicating a radial velocity and/or distance between the imaging system and an object external to the imaging system.

15. The method of claim 11, further comprising:
combining the light from the first light signal with light from a comparative signal so as to form a composite signal that is beating at a composite signal beat frequency,
the light from the comparative signal including light from the common signal that has exited from the imaging system, that has been reflected by an object located outside of the imaging system, and that has returned to the imaging system.

16. The method of claim 15, further comprising:
identifying the composite signal beat frequency.

17. The method of claim 16, further comprising:
calculating LIDAR data from the chirp rate calculated by the chirp rate generator and also from the composite signal beat frequency identified by the beat frequency identifier, the LIDAR data indicating a radial velocity and/or distance between the imaging system and an object external to the imaging system.

18. The method of claim 11, wherein a chirp rate detection component reflects the second light signal but transmits the light that is from the common signal and that is included in the comparative signal.

19. The method of claim 11, further comprising:
calculating an approximate duration of a delay between a time needed for the first light signal to travel between a signal splitter and a signal combiner and a time needed for the second light signal to travel between the signal splitter and the signal combiner,
the signal splitter configured to split the common light signal into the first light signal and the second light signal, and
the signal combiner configured to combine light from the first light signal and light from the second light signal.
